(19) United States
(12) Patent Application Publication
(10) Pub. No.: US 2025/0089612 A1
(43) Pub. Date: Mar. 20, 2025

(54) SYSTEMS AND METHODS TO SET GAIN CHARACTERISTIC LIMIT WITH GRAIN QUALITY CAMERA FEED

(71) Applicant: Deere & Company, Moline, IL (US)

(72) Inventors: Matthew T. Wold, Coal Valley, IL (US); Mario L. Donini, Bettendorf, IA (US); Brittany Elise Holthausen, Saint Louis, MO (US); Timothy J. Ofenloch, Chicago, IL (US)

(21) Appl. No.: 18/470,544

(22) Filed: Sep. 20, 2023

(51) Int. Cl. A01D 41/127

(52) U.S. Cl. CPC A01D 41/1277

(57) ABSTRACT

A mobile agricultural harvester comprises a grain camera configured to detect grain and generate a camera output indicative of the detected grain, a display screen, one or more processors, memory, and computer executable instructions, stored in the memory, and executable by the one or more processors. The computer executable instructions, when executed by the one or more processors, configure the one or more processors to generate and display on the display screen an interface comprising a grain camera display portion comprising a grain camera display element, a grain characteristic value display portion comprising a grain characteristic value display element indicative of a value of a grain characteristic, and a limit value adjuster display portion comprising an interactable limit value adjuster display element configured to receive operator or user interaction to adjust a limit value of the grain characteristic.

### FIELD OF THE DESCRIPTION

The present descriptions relate to mobile agricultural machines, particularly mobile agricultural harvesting machines configured to harvest at a field.

### BACKGROUND

There are a wide variety of different mobile agricultural machines. One such mobile agricultural machine is a mobile agricultural harvesting machine. The mobile agricultural harvesting machine can include a header that engages, gathers, and cuts crop at the field. The header further directs the cut crop material towards crop material processing functionality such that grain can be separated from material other than grain.

The discussion above is merely provided for general background information and is not intended to be used as an aid in determining the scope of the claimed subject matter.

### SUMMARY

A mobile agricultural harvester comprises a grain camera configured to detect grain and generate a camera output indicative of the detected grain, a display screen, one or more processors, memory, and computer executable instructions, stored in the memory, and executable by the one or more processors. The computer executable instructions, when executed by the one or more processors, configure the one or more processors to generate and display on the display screen an interface comprising a grain camera display portion comprising a grain camera display element, a grain characteristic value display portion comprising a grain characteristic value display element indicative of a value of a grain characteristic, and a limit value adjuster display portion comprising an interactable limit value adjuster display element configured to receive operator or user interaction to adjust a limit value of the grain characteristic.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 illustrates one example of a mobile agricultural harvesting machine.

FIG. 2 is a partial pictorial, partial schematic illustration of one example of a mobile agricultural harvesting machine.

FIG. 3 is a block diagram showing some portions of an agricultural corn harvesting system, including a mobile agricultural harvesting machine, in more detail, according to some examples of the present disclosure.

FIG. 4 is a block diagram showing one example of an interface generator.

FIG. 5 is a block diagram showing one example of a control determination system.

FIG. 6A is a block diagram showing one example of an interface.

FIG. 6B is a block diagram showing one example of an interface.

FIG. 7 is a pictorial illustration showing one example grain characteristic display portion.

FIG. 8 is a pictorial illustration showing one example grain characteristic display portion.

FIG. 9 is a pictorial illustration showing one example grain characteristic display portion.

FIG. 10 is a pictorial illustration showing one example grain characteristic display portion.

FIG. 11 is a partial pictorial illustration, partial block diagram showing one example interface.

FIG. 12 is a partial pictorial illustration, partial block diagram showing one example interface.

FIG. 13 is a flow chart illustrating one example of operation of an agricultural harvesting system in generating one or more interfaces.

FIG. 14 is a flow chart illustrating one example of operation of an agricultural harvesting system in controlling a harvester.

FIG. 15 is a block diagram showing one example of a mobile agricultural harvesting machine in communication with a remote server environment.

FIGS. 16-18 show examples of mobile devices that can be used in an agricultural harvesting system.

FIG. 19 is a block diagram showing one example of a computing environment that can be used in an agricultural harvesting system.

### DETAILED DESCRIPTION

For the purposes of promoting an understanding of the principles of the present disclosure, reference will now be made to the examples illustrated in the drawings, and specific language will be used to describe the same. It will nevertheless be understood that no limitation of the scope of the disclosure is intended. Any alterations and further modifications to the described devices, systems, methods, and any further application of the principles of the present disclosure are fully contemplated as would normally occur to one skilled in the art to which the disclosure relates. In particular, it is fully contemplated that the features, components, and/or steps described with respect to one example may be combined with the features, components, and/or steps described with respect to other examples of the present disclosure.

A mobile agricultural harvesting machine, such as combine harvester, can include a header, such as a corn header, a draper header (including a reel), as well as other forms of headers. The mobile agricultural harvesting machine travels across a field and the header engages, gathers, and cuts the crop. The header then propels the cut crop material towards crop processing functionality further back in the machine where the crop processing functionality separates the grain from material other than grain (MOG), deposits the grain in an on-board grain tank and expels the MOG from the machine. Often, and due to a one or more of a variety of reasons, grain and MOG are not perfectly separated such that MOG will accompany grain in the on-board grain tank, thus resulting in poorer quality grain. Grain cleanliness (e.g., the level (or amount) of MOG intermixed with the grain) is a factor that contributes to the eventual selling price of the grain. The sale price can, and often is reduced when the grain is dirty, or includes (is intermixed with) at least a threshold level of MOG. Additionally, or alternatively, grain can be broken during the harvesting process, including during the separation process. Broken grain is often considered as being of lesser quality. Grain brokenness is a factor that contributes to the (e.g., the level (or amount) of broken grain) contributes to the eventual selling price of the grain. The sale price can, and often is reduced when grain is broken, or is at least broken to a threshold level.

In some current systems operators or users, or both, set a limit for each of the factors grain cleanliness (e.g., clean grain) and grain brokenness (e.g., broken grain). These limit(s), along with sensor feedback, are then used to control one or more operating parameters of the harvesting machine. However, operators and users have struggled setting satisfactory limits, and rather prefer to look at the resultant grain and deem whether it is satisfactory.

Disclosed herein is a system that generates an interface and controls an interface mechanism to display the generated interface. The interface can include a camera display portion that displays an image or a live video from a camera that observes the grain or a camera display portion that is interactable to cause display of an image or a live video from a camera that observes the grain. The interface can further include a characteristic display portion that indicates a value for each of one or more grain characteristics, such as a grain cleanliness value or a grain brokenness value, or both. The interface can further include a portion that indicates a limit value for each one of one or more grain characteristics, such a limit value for grain cleanliness or a limit value for grain brokenness, or both. The interface can further include a portion that provides an operator or user interactable limit value adjustment display element, for each of the one or more displayed limit values, that is operable to receive an operator or a user input to adjust the corresponding limit value. The adjusted limit value, for each one of the one or more characteristics, is then used by a control system to control one or more operating parameters of the harvesting machine. In this way, an operator or user is able to observe, via the camera display portion, the effect of the current limit value(s) on the characteristic(s) of the grain and is able to adjust the limit value(s) based on their observation of the camera display portion within the same interface. It will be understood that, as used herein, limit can refer to a threshold or a max acceptable (or max desirable) level of a given characteristic and thus a limit value can be a threshold value or a max acceptable (or max desirable) value.

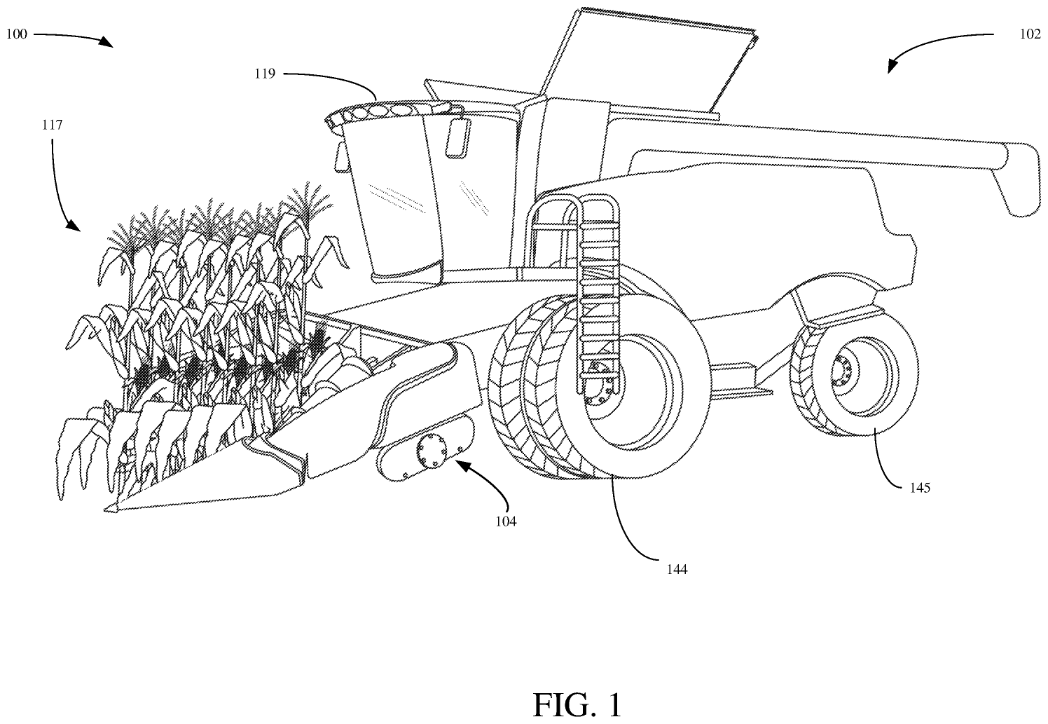

FIG. 1 is a perspective view that illustrates a mobile agricultural harvesting machine (or harvester) 100. Harvester 100 is illustratively shown as a self-propelled combine harvester 102 that includes a header 104. Header 104 engages, gathers, and cuts crop 117 at a field as the harvester travels over the field. While the example shown in FIG. 1, illustrates a corn header that engages, gathers, and cuts corn plants at a field as the harvester 100 travels over the field, in other examples, a mobile agricultural harvesting machine 100 can include a variety of different types of headers, such as a reel-type or draper header that engages, gathers, and cuts crop plants other than corn.

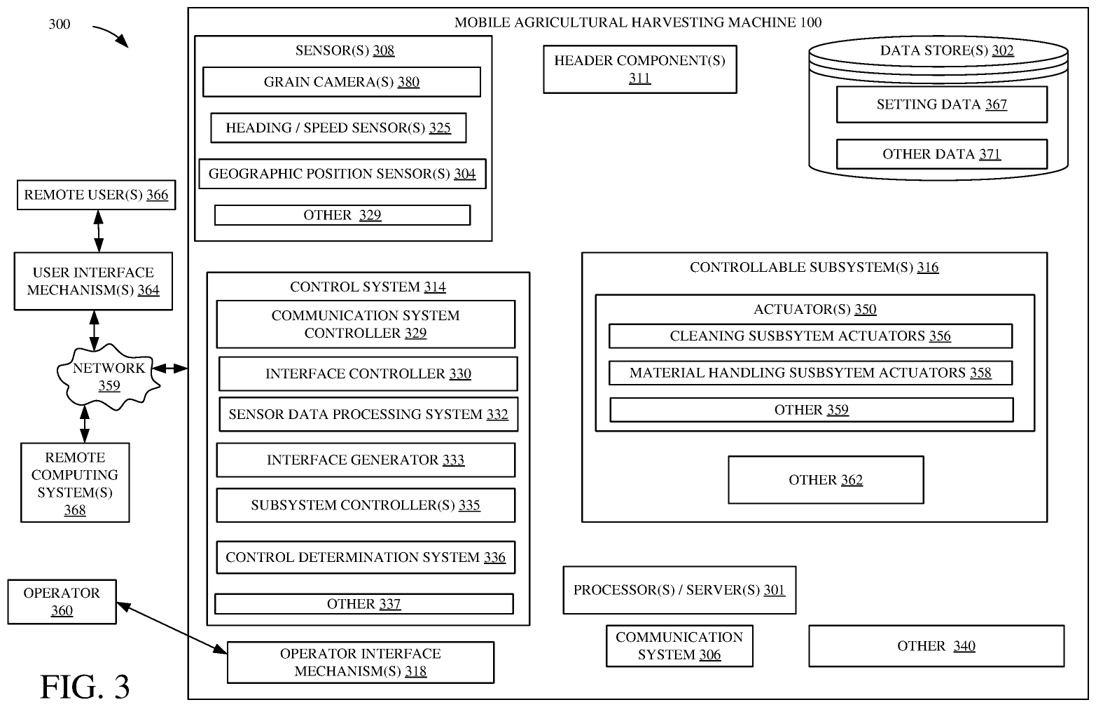

Harvester 100 further includes a set of ground engaging traction elements, such as front wheels 144 and rear wheels 145. In other examples, one or both of the front wheels 144 and rear wheels 145 can comprise other types of ground engaging traction elements, such as tracks. In some examples, one of the front wheels 144 and rear wheels 145 are used to steer while the other are driven by a propulsion subsystem to propel the harvester 100 across a field at which the harvester 100 operates. In the example illustrated, harvester 100 includes an operator compartment or cab 119, which can include a variety of different operator interface mechanisms (e.g., 318 shown in FIG. 3) for controlling harvester 100 as well as for displaying various information.

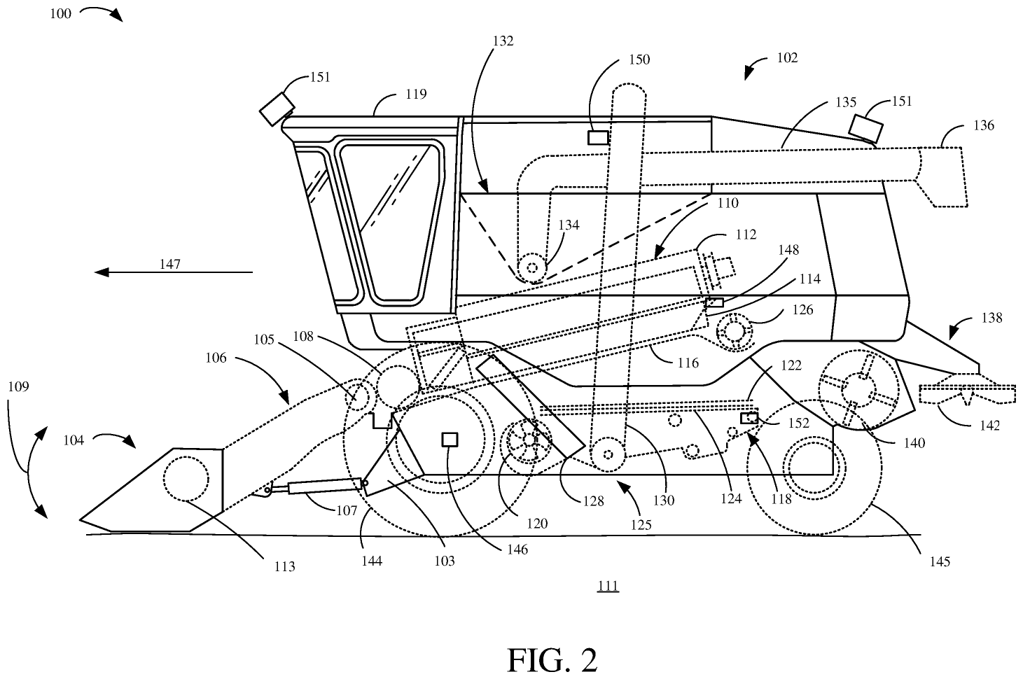

FIG. 2 is a partial pictorial, partial schematic, illustration of agricultural harvester 100. Some items in FIG. 2 are similar to items shown in FIG. 1 and thus are numbered similarly. As illustrated in FIG. 2, harvester 100 includes a feeder house 106, a feed accelerator 108, and a thresher generally indicated at 110. The feeder house 106 and the feed accelerator 108 form part of a material handling subsystem 125. Header 104 is pivotally coupled to a frame 103 of non-header portion 102 along pivot axis 105. One or more actuators 107 drive movement of header 104 about axis 105 in the direction generally indicated by arrow 109. Thus, a vertical position of header 104 (the header height) above ground 111 over which the header 104 travels is controllable by actuating actuator 107. While not shown in FIG. 1, agricultural harvester 100 may also include one or more actuators that operate to apply a tilt angle, a roll angle, or both to the header 104 or portions of header 104.

Agricultural harvester 100 includes a material handling subsystem 125 that includes a thresher 110 which illustratively includes a threshing rotor 112 and a set of concaves 114. Further, material handling subsystem 125 also includes a separator 116. Agricultural harvester 100 also includes a cleaning subsystem or cleaning shoe (collectively referred to as cleaning subsystem 118) that includes a cleaning fan 120, chaffer 122, and sieve 124. The material handling subsystem 125 also includes discharge beater 126, tailings elevator 128, and clean grain elevator 130. The clean grain elevator moves clean grain into clean grain tank 132.

Harvester 100 also includes a material transfer subsystem that includes a conveying mechanism 134, a chute 135, and a spout 136. Conveying mechanism 134 can be a variety of different types of conveying mechanisms, such as an auger or blower. Conveying mechanism 134 is in communication with clean grain tank 132 and is driven to convey material from grain tank 132 through chute 135 and spout 136. Chute 135 is rotatable through a range of positions from a storage position (shown in FIG. 2) to a variety of positions away from agricultural harvester 100 to align spout 136 relative to a material receptacle (e.g., grain cart, towed trailer, etc.) that is configured to receive the material within grain tank 132. Spout 136, in some examples, is also rotatable to adjust the direction of the crop stream exiting spout 136.

Harvester 100 also includes a residue subsystem 138 that can include chopper 140 and spreader 142. Harvester 100 also includes a propulsion subsystem that includes an engine (or other form of power plant) that drives ground engaging traction components, such as 144 or 144 and 145 to propel the harvester 100 across a worksite such as a field (e.g., ground 111). In some examples, a harvester within the scope of the present disclosure may have more than one of any of the subsystems mentioned above. In some examples, harvester 100 may have left and right cleaning subsystems, separators, etc., which are not shown in FIG. 2.

In operation, and by way of overview, harvester 100 illustratively moves through a field 111 in the direction indicated by arrow 147. As harvester 100 moves, header 104 engages the crop plants to be harvested and cuts (with a cutter bar on the header 104, not shown in FIG. 2) the crop plants to generate cup crop material.

The cut crop material is engaged by a cross auger 113 which conveys the separated crop material to a center of the header 104 where the severed crop material is then moved through a conveyor in feeder house 106 toward feed accelerator 108, which accelerates the separated crop material into thresher 110. The separated crop material is threshed by rotor 112 rotating the crop against concaves 114. The threshed crop material is moved by a separator rotor in separator 116 where a portion of the residue is moved by discharge beater 126 toward the residue subsystem 138. The portion of residue transferred to the residue subsystem 138 is chopped by residue chopper 140 and spread on the field by spreader 142. In other configurations, the residue is released from the agricultural harvester 100 in a windrow.

Grain falls to cleaning subsystem 118. Chaffer 122 separates some larger pieces of MOG from the grain, and sieve 124 separates some of finer pieces of MOG from the grain. The grain then falls to an auger that moves the grain to an inlet end of grain elevator 130, and the grain elevator 130 moves the grain upwards, depositing the grain in grain tank 132. Residue is removed from the cleaning subsystem 118 by airflow generated by cleaning fan 120. Cleaning fan 120 directs air along an airflow path upwardly through the sieves and chaffers. The airflow carries residue rearwardly in harvester 100 toward the residue handling subsystem 138.

Tailings elevator 128 returns tailings to thresher 110 where the tailings are re-threshed. Alternatively, the tailings also may be passed to a separate re-threshing mechanism by a tailings elevator or another transport device where the tailings are re-threshed as well.

Harvester 100 can include a variety of sensors, some of which are illustrated in FIG. 2, such as ground speed sensor 146, one or more separator loss sensors 148, a grain camera 150, one or more loss sensors 152 provided in the cleaning subsystem 118, and an observation sensor systems 151, which may include, one or more of one or more imaging systems (e.g., mono or stereo cameras), optical sensors, lidar, radar, ultrasonic sensors, thermal or infrared sensors, as well as various other sensors, such as sensors that emit and/or received electromagnetic radiation.

Ground speed sensor 146 senses the travel speed of harvester 100 over the ground. Ground speed sensor 146 may sense the travel speed of the harvester 100 by sensing the speed of rotation of the ground engaging traction elements (such as wheels or tracks), a drive shaft, an axle, or other components. In some instances, the travel speed may be sensed using a positioning system, such as a global positioning system (GPS), a dead reckoning system, a long range navigation (LORAN) system, a Doppler speed sensor, or a wide variety of other systems or sensors that provide an indication of travel speed. Ground speed sensors 146 can also include direction sensors such as a compass, a magnetometer, a gravimetric sensor, a gyroscope, GPS derivation, to determine the direction of travel in two or three dimensions in combination with the speed. This way, when harvester 100 is on a slope, the orientation of harvester 100 relative to the slope is known. For example, an orientation of harvester 100 could include ascending, descending or transversely travelling the slope.

Loss sensors 152 illustratively provide an output signal indicative of the quantity of grain loss occurring in both the right and left sides of the cleaning subsystem 118. In some examples, sensors 152 are strike sensors which count grain strikes per unit of time or per unit of distance traveled to provide an indication of the grain loss occurring at the cleaning subsystem 118. The strike sensors for the right and left sides of the cleaning subsystem 118 may provide individual signals or a combined or aggregated signal. In some examples, sensors 152 may include a single sensor as opposed to separate sensors provided for each cleaning subsystem 118.

Separator loss sensor 148 provides a signal indicative of grain loss in the left and right separators, not separately shown in FIG. 2. The separator loss sensors 148 may be associated with the left and right separators and may provide separate grain loss signals or a combined or aggregate signal. In some instances, sensing grain loss in the separators may also be performed using a wide variety of different types of sensors as well.

Grain camera 150 illustratively observes the grain. Grain camera 150 may detect various characteristics, such as the cleanliness of the grain. For example, grain camera 150 may detect an amount of MOG (also sometimes referred to as foreign material) comingled with the grain. Additionally, grain camera may detect brokenness of the grain. For example, grain camera 150 may detect an amount of broken grains. Grain camera 150 may detect various other characteristics. In one example, grain camera 150 is disposed in a bypass, coupled to grain elevator 130, through which at least some grain is directed and observed by grain camera 150. In other examples, grain camera 150 can be disposed at various other locations, for example, but not by limitation, positioned to view the grain flowing into the grain tank, such as the grain exits the grain elevator and flows into the grain tank fill auger or as the grain sits in the grain tank.

Observation sensor systems 151 are disposed to observe various characteristics at the worksite. For example, observation sensor systems 151 may detect characteristics around harvester 100 as well as characteristics on harvester 100 (e.g., characteristics on header 104). For example, one observation sensor system 151 may be disposed to detect characteristics occurring at or on header 104, such as grain loss, MOG intake, stalk diameter, car size, as well as various other characteristics. Another observation sensor system 151 may be disposed to view rearwardly of the harvester 100 to detect various characteristics such as the amount of residue as well as grain loss (an amount of grain being output with the residue). Another observation sensor system 151 may be disposed to view tailings (or other material) being transported by tailings elevator 128. These are merely some examples. Observation sensor systems 151 may comprise or may include one or a combination of camera(s) (e.g., mono or stereo camera(s), etc.), Lidar, Radar, Ultrasonic sensors, as well as various other sensors that are configured to emit and/or receive electromagnetic radiation.

Harvester 100 can include various other sensors, some of which will be discussed below.

FIG. 3 is a block diagram showing some portions of an agricultural harvesting system architecture 300 (herein also referred to as “agricultural system” or “agricultural harvesting system”). FIG. 3 shows that agricultural system 300 includes mobile agricultural harvesting machine 100 (also referred to herein as harvester 100 or mobile machine 100), one or more remote computing systems 368, and one or more remote user interfaces 364. Harvester 100, itself, illustratively includes one or more processors or servers 301, one or more data stores 302, communication system 306, and one or more sensors 308 that sense one or more characteristics at a worksite (e.g., a field). Harvester 100 also includes control system 314, one or more controllable subsystems 316, and operator interface mechanisms 318. Harvester 100 can also include a wide variety of other items and functionality 340, some of which is described elsewhere herein.

Data stores 302 store a variety of data. For example, data stores 302 can include, among other things, setting data 367 as well as various other data 371, some of which will be described below. Other data 371 can include, for example, computer executable instructions, executable by the one or more processors or servers 302, that, when executed by the one or more processors or servers 302, configure the one or more processors or servers 302 to implement or provide various other components or functionalities of harvester 100 described herein. It will be understood that data stores 302 can include different forms of data stores, for instance, one or more of volatile data stores (e.g., Random Access Memory (RAM)) and non-volatile data stores (e.g., Read Only Memory (ROM), hard drives, solid state drives, etc.). Other data 371 can also include various other data such as data indicative of various characteristics of the field at which mobile agricultural harvesting machine 100 is operating (e.g., historical performance data relative to the particular field, etc.), characteristic of the crop at the field such as crop type or other characteristics of the crop, characteristics of the particular harvester 100 (e.g., historical performance data, operating ranges, model of the harvester, power ratings, etc.), as well as various other information, including information provided by an operator or user or data provided in other ways.

Sensors 308 sense characteristics at a worksite during the course of an operation. Sensors 308 illustratively include one or more grain cameras 380, one or more heading/speed sensors 325, one or more geographic position sensors 304, and can include various other sensors 329.

Grain cameras 380 captures image(s) (e.g., still images or video) of grain gathered by harvester 100. The image(s) are indicative of one or more characteristics of the gathered grain, such as the cleanliness of the grain, the brokenness of the grain, as well as a variety of other characteristics. Thus, grain cameras 380 detect various characteristics of gathered grain. Grain cameras 380 can be similar to grain camera 150 shown in FIG. 1 or can be a variety of other cameras.

Geographic position sensors 304 illustratively sense or detect the geographic position or location of harvester 100. Geographic position sensors 304 can include, but are not limited to, a global navigation satellite system (GNSS) receiver that receives signals from a GNSS satellite transmitter. Geographic position sensors 304 can also include a real-time kinematic (RTK) component that is configured to enhance the precision of position data derived from the GNSS signal. Geographic position sensors 304 can include a dead reckoning system, a cellular triangulation system, or any of a variety of other geographic position sensors. In some examples, the geographic position or location detected by geographic position sensors 304 can be processed to derive a geographic position or location of a given component of harvester 100. The dimensions of the mobile machine, such as the distance of certain components from the geographic position sensors 304, which can be stored in data store 302 (e.g., part of other data 371) or otherwise provided, can be used, in combination with detected geographic position or location, to derive the geographic position or location of the component. This processing can be implemented by processors or servers 302.

Heading/speed sensors 325 detect a heading and speed at which harvester 100 is traversing the worksite during the operation. This can include sensors that sense the movement of ground engaging traction elements (e.g., 144 or 145, or both) or can utilize signals received from other sources, such as geographic position sensor 304. Thus, while heading/speed sensors 325 as described herein are shown as separate from geographic position sensor 304, in some examples, machine heading/speed is derived from signals received from geographic positions sensors 304 and subsequent processing. In other examples, heading/speed sensors 325 are separate sensors and do not utilize signals received from other sources.

Other sensors 327 may be any of a variety of other types of sensors, including some of the sensors previously described herein.

FIG. 3 shows that an operator 360 may operate harvester 100. The operator 360 interacts with operator interface mechanisms 318. The operator 360 may be local to harvester 100 or may be remote from harvester 100. In some examples, operator interface mechanisms 318 may include joysticks, levers, a steering wheel, linkages, pedals, buttons, key fobs, wireless devices, such as mobile computing devices, dials, keypads, a display device with actuatable display elements (such as icons, buttons, etc.), a microphone and speaker (where speech recognition and speech synthesis are provided), among a wide variety of other types of control devices. Where a display device with a touch sensitive screen is provided, as an operator interface mechanism 318, operator 360 may interact with operator interface mechanisms 318 using touch gestures. These examples described above are provided as illustrative examples and are not intended to limit the scope of the present disclosure. Consequently, other types of operator interface mechanisms 318 may be used and are within the scope of the present disclosure.

FIG. 3 also shows one or more remote users 366 interacting with harvester 100 or remote computing systems 368, or both, through user interface mechanisms 364 over network 359. User interface mechanisms 364 can include joysticks, levers, a steering wheel, linkages, pedals, buttons, key fobs, wireless devices, such as mobile computing devices, dials, keypads, a display device with actuatable display elements (such as icons, buttons, etc.), a microphone and speaker (where speech recognition and speech synthesis are provided), among a wide variety of other types of control devices. Where a display device with a touch sensitive screen is provided, as a user interface mechanism 364, a user 366 may interact with user interface mechanisms 364 using touch gestures. These examples described above are provided as illustrative examples and are not intended to limit the scope of the present disclosure. Consequently, other types of user interface mechanisms 364 may be used and are within the scope of the present disclosure.

Remote computing systems 368 can be a wide variety of different types of systems, or combinations thereof. For example, remote computing systems 368 can be in a remote server environment. Further, remote computing systems 368 can be remote computing systems, such as mobile devices, a remote network, a farm manager system, a vendor system, or a wide variety of other remote systems. In one example, harvester 100 can be controlled remotely by remote computing systems 368 or by remote users 366, or both. As will be described below, in some examples, one or more of the components shown being disposed on harvester 100 in FIG. 3 can be located elsewhere, such as at remote computing systems 368 and/or user interface mechanisms 364.

FIG. 3 also shows that harvester 100 includes a control system 314 and one or more controllable subsystems 316. Control system 314 includes communication system controller 329, interface controller 330, sensor data processing system 332, interface generator 333, one or more subsystem controllers 335, control determination system 336, and can include other items 337. Controllable subsystems 316 can include one or more header subsystem actuators 350, one or more propulsion subsystem actuators 352, one or more steering subsystem actuators 354, one or more cleaning subsystem actuators 356, one or more material handling subsystem actuators 358, one or more residue subsystem actuators 360, and can include other items 362.

In some examples, communication system controller 329 controls communication system 306 to communicate with various other items of agricultural system 300 such as to send and receive various items.

Interface controller 330 is operable to generate control signals to control interface mechanisms, such as operator interface mechanisms 318 or user interface mechanisms 364, or both, to generate (e.g., display) interfaces generated by interface generator 333. Interface generator 333 will be described in more detail below.

Sensor data processing system 332 is configured to process sensor data (e.g., images, signals, etc.) generated by sensors 308 and to generate processed sensor data. The processed sensor data can be indicative of values of one or more characteristics detected by sensors 308. For example, processed sensor data can be indicative of values of characteristics of grain detected by grain cameras 380, for example, grain cleanliness values or grain brokenness values, or both. Similarly, processed sensor data can be indicative of values of various other characteristics detected by sensors 308 such as heading values or speed values, or both, based on sensor data generated by heading/speed sensors 325, geographic position values based on sensor data generated by geographic position sensors 304, as well as various other characteristic values based on sensor data generated by other sensors 329.

Sensor data processing system 332 can include or utilize various processing functionalities, including, but not limited to, filtering, categorization, aggregation, normalization, analog-to-digital conversion, as well as various other functionalities. Additionally, sensor data processing system 332 can include or utilize various image processing functionalities such as sequential image comparison, color extraction (e.g., RGB color extraction, etc.), edge detection, black/white analysis, pixel testing, pixel clustering, shape detection, as well as any number of other suitable image processing functionalities. Additionally, sensor data processing system 332 can include or utilize various machine learning functionalities or various artificial intelligence functionalities, or both.

Subsystem controllers 335 are operable to generate control signals to control one or more controllable subsystems 316. For example, subsystem controllers 335 can generate control signals to control one or more controllable subsystems 316 based on operating parameters output by control determination system 336. Control determination system 336 will be described in more detail below. Controllable subsystems 316 can include one or more actuators 350 (e.g., hydraulic, pneumatic, electric, etc.) actuators for controlling or adjusting operating parameters of one or more components of harvester 100. In the illustrated example, actuators 350 can include one or more cleaning subsystem actuators 356, one or more material handling subsystem actuators 358, and can include various other actuators 359.

Cleaning subsystem actuators 356 can include actuators that are controllable to adjust operating parameters of various components of cleaning subsystem 118, such as a speed of cleaning fan 120, a position (e.g., to control the size of openings) of chaffer 122 or of sieve 124, or both. These are merely some examples.

Material handling subsystem actuators 358 can include actuators that are controllable to adjust operating parameters of various components of material handling subsystem 125, such as a speed of threshing rotor 112, a position of concave(s) 114 to control a spacing between the concave(s) 114 and threshing rotor 112 (sometimes referred to as concave clearance), a speed of discharge beater 126, a speed of tailings elevator 128, or a speed of grain elevator 130. These are merely some examples.

Other actuators 359 can include various other actuators that are controllable to adjust operating parameters of various other components of harvester 100.

Harvester 100 can include a variety of other controllable subsystems 362, including some of those discussed previously in FIG. 1. These other controllable subsystems 362 can include various actuators for controlling operating parameters (e.g., position, speed, etc.) of various corresponding components of the harvester 100.

While the illustrated example of FIG. 3 shows that various components of agricultural system 300 are located on harvester 100, it will be understood that in other examples one or more of the components illustrated on harvester 100 in FIG. 3 can be located at other locations, such as one or more remote computing systems 368 or remote user interface mechanisms 364. For instance, one or more of data stores 302 (or one or more components thereof), interface generator 333 (or one or more components thereof), and control determination system 336 (or one or more components thereof) can be located remotely from harvester 100 but can communicate with harvester 100 via communication system 306 and network 359. Similarly, information generated by the harvester 100 (e.g., sensor data generated by sensors 308) may be provided to the remote locations over network 359.

In some examples, control system 314 (or one or more components thereof) can be located remotely from harvester 100 such as at one or more of remote computing systems 368 and remote user interface mechanisms 364. In other examples, a remote location, such as remote computing systems 368 or user interface mechanisms 364, or both, may include a respective control system which generates control values that can be communicated to harvester 100 and used by on-board control system 314 to control the operation of harvester 100. These are merely examples.

It will be noted that network 359 can comprise one or more of a cellular network, a wide area network, a local area network, a near field communication network, or any of a variety of other networks or combinations of networks.

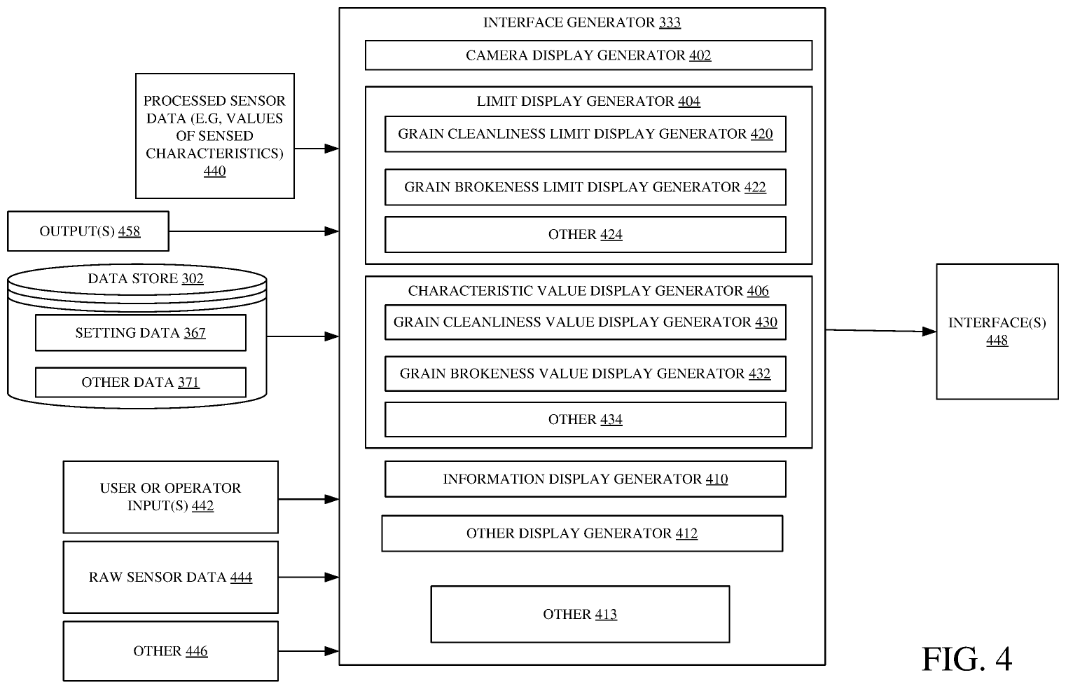

FIG. 4 is a block diagram of a portion of the agricultural harvesting system architecture 300 shown in FIG. 3. Particularly, FIG. 4 shows, among other things, examples of the interface generator 333 in more detail. As illustrated in FIG. 4, interface generator 333 includes camera display generator 402, limit display generator 404, characteristic value display generator 406, information display generator 410, other display generator 412, and can include other items 413 as well.

Limit display generator 404, itself, includes grain cleanliness limit display generator 420, grain brokenness display generator 422, and can include various other items 424.

Characteristic value display generator 406, itself, includes grain cleanliness value display generator 430, grain brokenness value display generator 432, and can include various other items 434 as well.

As a general overview, interface generator 333 obtains (e.g., receives or retrieves) various data, such as processed sensor data 440 generated by sensor data processing system 332, user or operator inputs 442 received through an interface mechanism (e.g., 318 or 364, etc.), raw sensor data 444 generated by sensors 308, data from data stores 302, outputs 458 generated by control determination system 336, as well as various other data 446. Interface generator 333 then generates, as output(s), one or more interfaces 448 based on one or more of the obtained data.

Camera display generator 402 generates, an interface 448, or a portion of an interface 448, that includes a camera display element(s) that displays image(s) (or a video feed) of grain cameras 380 or image(s) (or video feed) of other sensors, such as observations systems 151, or both. The image(s) (or video feed) of grain cameras 380 or of other sensors (e.g., observation systems 151), or both, can be provided as raw sensor data 444, or, if some processing is done on the image(s) (or video feed) then as processed sensor data 440.

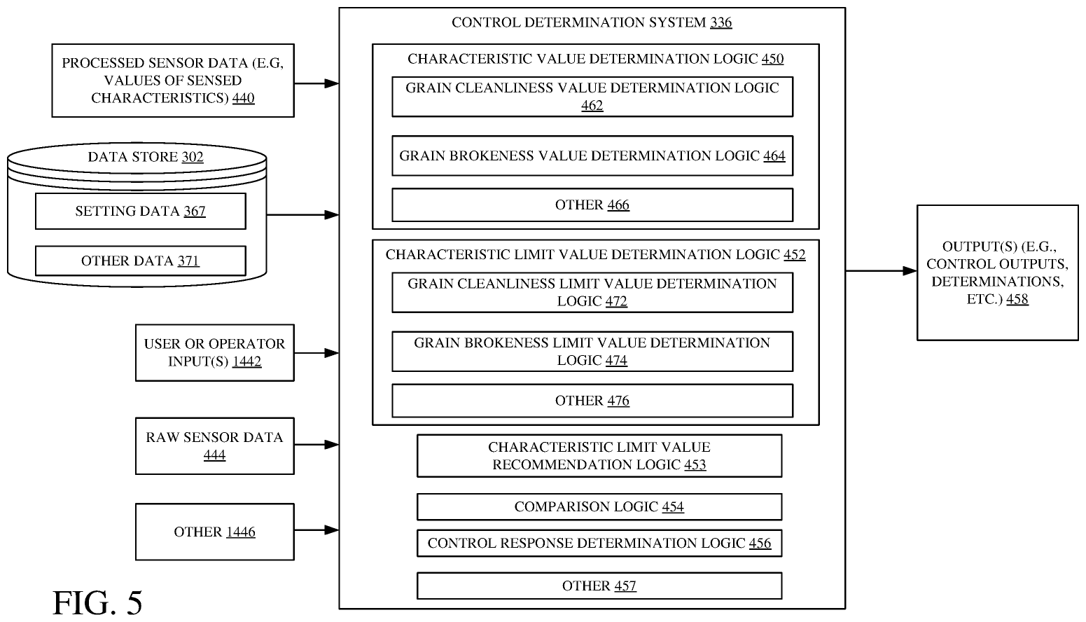

Limit display generator 404 generates, an interface 448, or a portion of an interface 448, that includes display elements that display limit values as well as limit value adjuster display elements. Grain cleanliness limit display generator 420 generates, an interface 448, or a portion of an interface 448, that includes a grain cleanliness limit value display element indicative of a current value of a grain cleanliness limit and a grain cleanliness limit adjuster display element that is interactable (by an operator 360 or user 366, or both) to adjust the current value of the grain cleanliness limit. Grain brokenness limit display generator 422 generates, an interface 448, or a portion of an interface 448, that includes a grain brokenness limit value display element indicative of a current value of a grain brokenness limit and a grain brokenness limit adjuster display element that is interactable (by an operator 360 or user 366, or both) to adjust the current value of the grain brokenness limit. Limit display generator 404 generates interfaces 448, or portions of interfaces 448, including display elements based on user or operator inputs 442, for instance, the current limit values may be based on user or operator inputs 442. In other examples, the current limit values may be based on various other data 446, such as default, preset, or recommend values provided by the manufacturer, or some other party. In yet other examples, the current limit values may be based on outputs 458 generated by control determination system 336, which are described in more detail in FIG. 5.

It will be understood that limit display generator 404 can include various other characteristic limit specific display generators 424 that each generate, an interface 448, or a portion of an interface 448, that includes limit value display elements and limit adjust display elements for a respective characteristic other than grain cleanliness and grain brokenness.

Characteristic value display generator 406 generates, an interface 448, or a portion of an interface 448, that includes display elements that display current characteristic values. It will be understood that current values can be real or near-real time values (e.g., a most recently detected value) or can be a current average value, that is, the current average of the characteristic value over a given period (e.g., a value that is an aggregation of a plurality of previously detected values). Grain cleanliness value display generator 430 generates, an interface 448, or a portion of an interface 448, that includes a grain cleanliness value display element indicative of a current grain cleanliness value. Grain brokenness value display generator 432 generates, an interface 448, or a portion of an interface 448, that includes a grain brokenness value display element indicative of a current grain brokenness value. Characteristic value display generator 406 generates interfaces 448, or portions of interfaces 448, that include display elements based on processed sensor data 440 generated by sensor data processing system 332. In one example, the current characteristic values may be based on sensor data, such as processed sensor data 440 or raw sensor data 444. In yet other examples, the current characteristic values may be based on outputs 458 generated by control determination system 336, which are described in more detail in FIG. 5.

It will be understood that limit display generator 404 can include various other characteristic limit specific display generators 424 that each generate, an interface 448, or a portion of an interface 448, that includes limit value display elements and limit adjust display elements for a respective characteristic other than grain cleanliness and grain brokenness.

Information display element generator 411 generates an interface 448, or a portion of an interface 448, that includes information display elements that can display information in various forms.

Other display generator 412 generates an interface 448, or a portion of an interface 448, that includes various other display elements, such as interactable display elements.

Thus, it can be seen that interface generator 333 is operable to generate one or more interfaces 448.

For example, interface generator 333 is operable to generate an interface 448 that includes a combination (e.g., two or more of the following portions) of: a camera display portion that includes a display element that displays image(s) (or a video feed) of grain cameras 380; a limit display portion that includes one or more display elements that display limit values (e.g., a grain cleanliness limit value display element or a grain brokenness limit value display element, or both) and includes one or more limit value adjuster display elements (e.g., a grain cleanliness limit adjuster display element or a grain brokenness limit adjuster display element, or both); or a characteristic value display portion that includes one or more display elements that display current characteristic values (e.g., a grain cleanliness value display element or a grain brokenness value display element, or both).

In another example, instead of being part of the same interface 448, each of the portions discussed above can be part of a separate interface 448. For example, interface generator 333 is operable to generate one or more of: a first interface 448 that includes a display element that displays image(s) (or a video feed) of grain cameras 380; a second interface 448 that includes a limit display portion that includes one or more display elements that display limit values (e.g., a grain cleanliness limit value display element or a grain brokenness limit value display element, or both) and includes one or more limit value adjuster display elements (e.g., a grain cleanliness limit adjuster display element or a grain brokenness limit adjuster display element, or both); or a third interface that includes characteristic value display portion that includes one or more display elements that display current characteristic values (e.g., a grain cleanliness value display element or a grain brokenness value display element, or both).

Interface controller 330 is operable to control one or more interface mechanisms (e.g., 318 or 364, etc.) to display interface(s) 448.

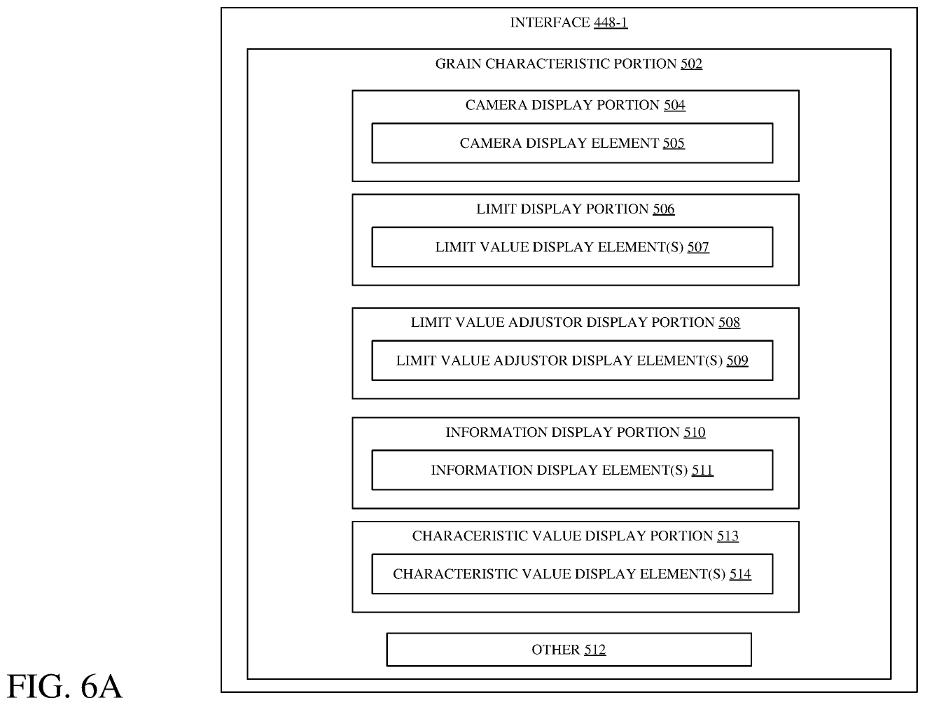

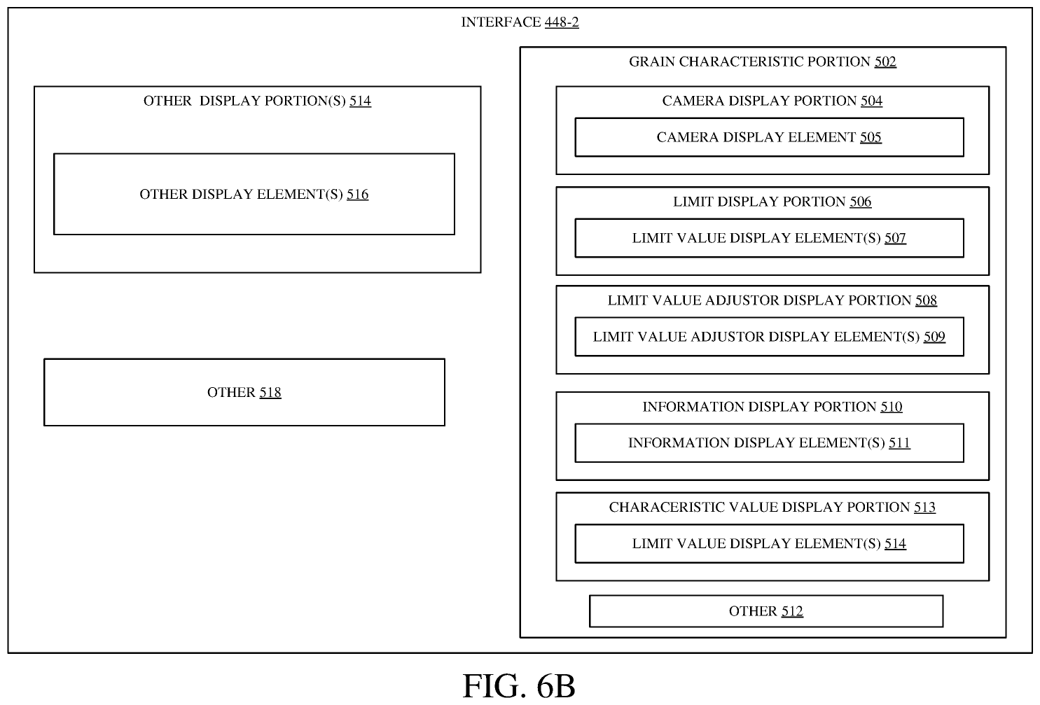

Some example interfaces 448 are shown below in FIGS. 6-12.

FIG. 5 is a block diagram of a portion of the agricultural harvesting system architecture 300 shown in FIG. 3. Particularly, FIG. 3 shows, among other things, examples of the control determination system 336 in more detail. As illustrated in FIG. 5, control determination system 336 includes characteristic value determination logic 450, characteristic limit value determination logic 452, characteristic limit value recommendation logic 453, comparison logic 454, control response determination logic 456, and can include other items 457 as well.

Characteristic value determination logic 450, itself, includes grain cleanliness value determination logic 462, grain brokenness value determination logic 464, and can include various other items 466.

Characteristic limit value determination logic 452, itself, includes grain cleanliness limit determination value determination logic 472, grain brokenness limit value determination logic 474, and can include various other items 476.

As a general overview, control determination system 336 obtains (e.g., receives or retrieves) various data, such as processed sensor data 440 generated by processing system 332, user or operator inputs 1442 received through an interface mechanism (e.g., 318 or 364, etc.), raw sensor data 444 generated by sensors 308, data from data stores 302, as well as various other data 1446. Control determination system 336 then generates one or more outputs 458 based on one or more of the obtained data.

Characteristic value determination logic 450 determines values of one or more characteristics detected by sensors 308. For example, grain cleanliness value determination logic 462 determines grain cleanliness values based on sensor data generated by grain cameras 380. A grain cleanliness value may be a real time or near-real time value (e.g., a most recently detected value) or may be an average of a grain cleanliness value over a given period (e.g., a value that is an aggregation of a plurality of previously detected grain brokenness values). The sensor data may be processed sensor data 440 or may be raw sensor data 444. Grain brokenness value determination logic 464 determines grain brokenness values based on sensor data generated by grain cameras 380. A grain brokenness value may be a real time or near-real time value (e.g., a most recently detected value) or may be an average of a grain brokenness value over a given period (e.g., a value that is an aggregation of a plurality of previously detected grain brokenness values). The sensor data may be processed sensor data 440 or may be raw sensor data 444. It will be understood that characteristic value determination logic 450 can include various other logic 466 that determines values of various other characteristics.

Characteristic limit value determination logic 452 determines values of one or more characteristic limits. For example, grain cleanliness limit value determination logic 472 determines grain cleanliness limit values based on operator or user inputs 1442 provided through an interface (e.g., 448) on an interface mechanism (e.g., 318 or 364, etc.), such as an operator or user inputs that adjust or set limit values. In another example, grain cleanliness limit values may be based on various other data 1446, such as default, preset, or recommend values provided by the manufacturer, or some other party. Grain brokenness limit value determination logic 474 determines grain brokenness limit values based on operator or user inputs 1442 provided through an interface (e.g., 448) on an interface mechanism (e.g., 318 or 364, etc.), such as operator or user inputs that adjust or set limit values. In another example, grain brokenness limit values may be based on may be based on various other data 1446, such as default, preset, or recommend values provided by the manufacturer, or some other party. It will be understood that limit value determination logic 452 can include various other logic 476 that determines limit values of various other characteristics.

Comparison logic 454 compares characteristic values, determined by characteristic value determination logic 450, to corresponding characteristic limit values, determined by characteristic limit value determination logic 452 and generates comparison outputs indicative thereof. It will be understood that a comparison output can indicate a difference or whether there is a difference between two values (e.g., between a characteristic value and a characteristic limit value). For example, comparison logic 454 may compare a grain cleanliness value determined by grain cleanliness determination logic 462 to a corresponding grain cleanliness limit value determined by grain cleanliness limit value determination logic 472 and generate a comparison output indicative thereof. Comparison logic 454 may compare a grain brokenness value determined by grain brokenness determination logic 462 to a corresponding grain brokenness limit value determined by grain brokenness limit value determination logic 474 and generate a comparison output indicative thereof. It will be understood that comparison logic 454 can compare values of various other characteristics to corresponding limit values and generate comparison outputs indicative thereof.

Control response determination logic 456 determines and provides, as outputs 458, control outputs that are useable by other items of control system 314 (e.g., communication system controller 329, interface controller 330, subsystem controller 335, etc.) to control one or more other items of agricultural system 300 (e.g., communication system 306, interfaces 318 or 364, or controllable subsystems 316) based on the characteristic values determined by characteristic value determination logic 450 and corresponding characteristic limit values determined characteristic limit value determination logic 452, as well as other data, such as setting data 367. In some examples, control response determination logic 456 determines and provides the control outputs based on comparison outputs provided by comparison logic 454. For example, where a characteristic value deviates (or deviates by a threshold amount) from a corresponding characteristic limit value, control response determination logic 456 may generate a control output. A control output may define a setting for one or more 316 that are useable by subsystem controllers 335 to generate control signals to adjust (or otherwise set) the settings of one or more controllable subsystems 316. The setting data 367 may be various control algorithms, models (including machine learned models), or lookup tables useable by control response determination logic 456 to generate a control output. For example, the setting data 367 may define how operation of the harvester 100 (e.g., operation of one or more controllable subsystems 316) is to adjust based on a characteristic value (e.g., grain cleanliness or grain brokenness) deviating from (or otherwise not satisfying) a corresponding characteristic limit value (e.g., grain cleanliness limit or grain brokenness limit).

Characteristic limit value recommendation logic 453 determines and provides, as outputs 458, characteristic limit value recommendations (e.g., a grain cleanliness limit value recommendation or a grain brokenness limit value recommendation, or both) which can be provided to a user or an operator, or both, such as by display. The characteristic limit value recommendations may recommend a characteristic limit value that should be set by an operator or user. Characteristic limit value recommendation logic 453 may determine a characteristic limit value recommendation based on upon various data, such as other data 371 indicative of one or more of a crop type being harvested by harvester 100, the particular field at which the harvester 100 is harvesting, as well as information associated with the particular harvester 100 (e.g., historical performance data, model of the harvester, operating ranges, power ratings, etc.).

FIG. 6A is a block diagram illustrating one example user interface 448 (illustratively shown as 448-1) generated by interface generator 333. As shown in FIG. 6A user interface 448-1 includes a grain characteristic portion 502. Grain characteristic portion 502 includes: a camera display portion 504 that includes a camera display element 505; a limit display portion 506 that includes one or more limit value display elements 507; a limit value adjuster display portion 508 that includes one or more interactable limit value adjuster display elements 509; an information display portion 510 that includes one or more information display elements 511; a characteristic value display portion 513 that includes one or more characteristic value display elements 514, and can include various other items 512, such as various other display elements.

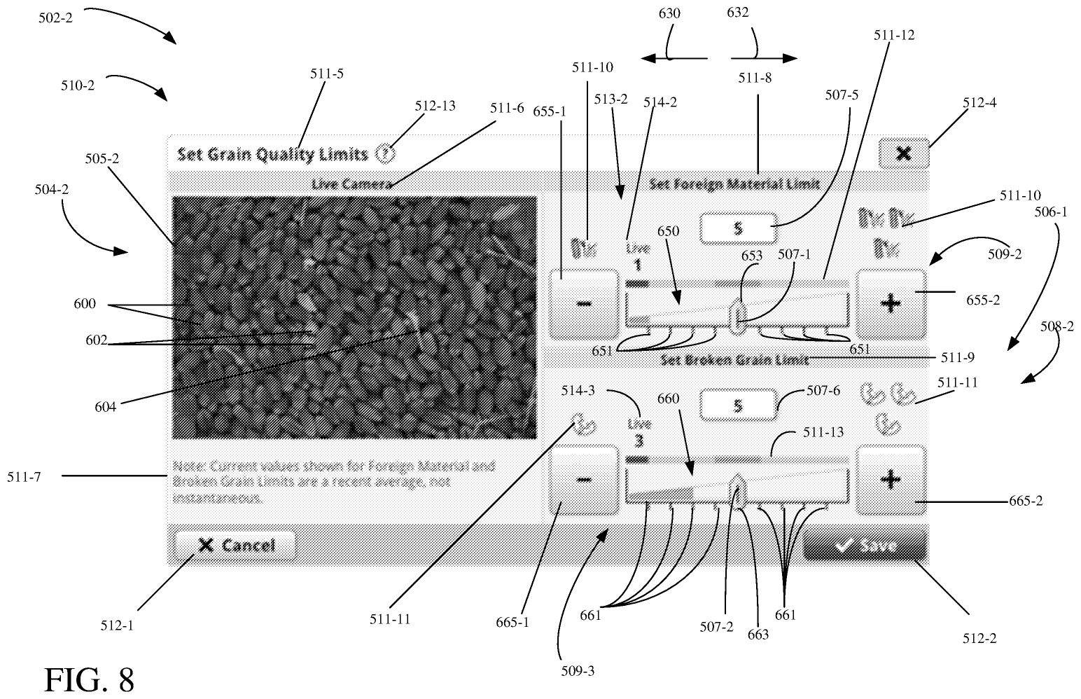

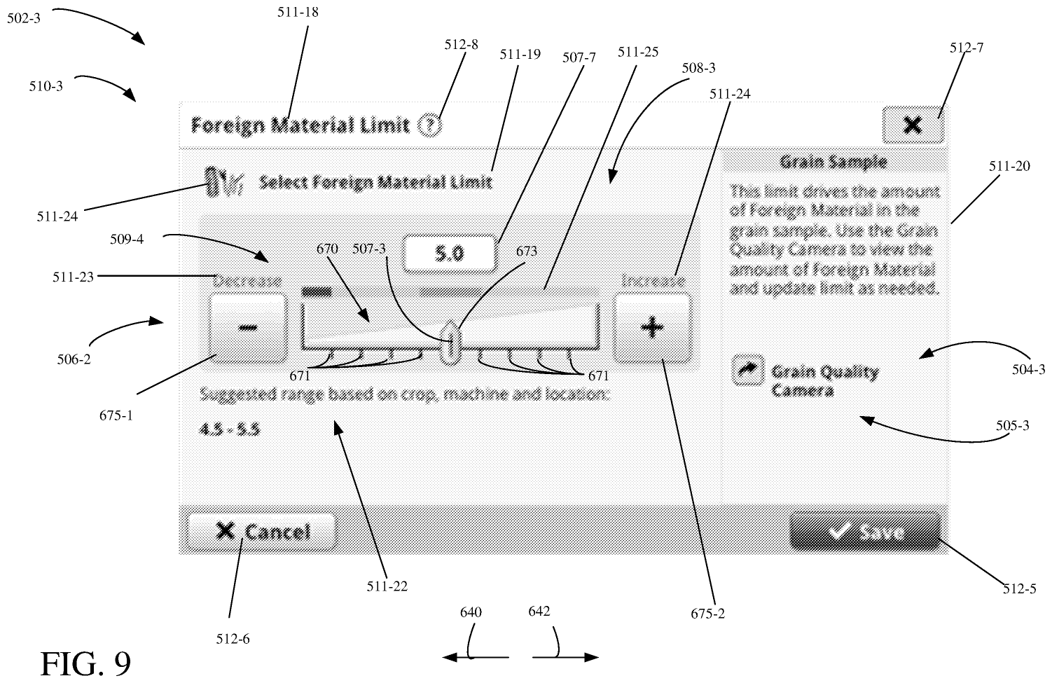

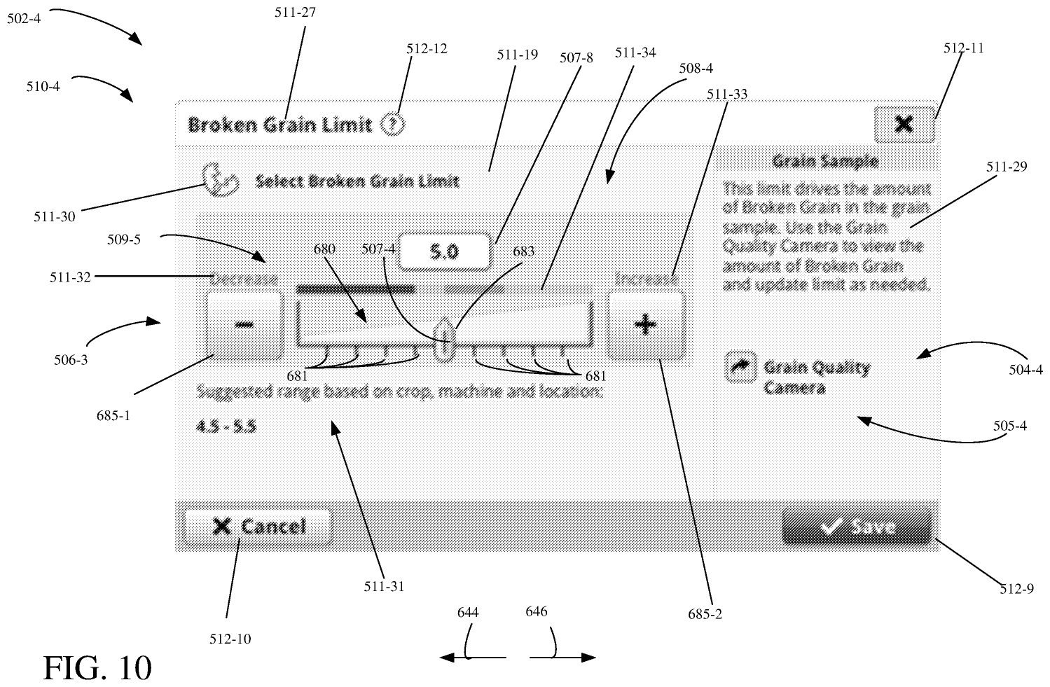

Camera display portion 504 includes a camera display element 505. In one example, camera display element 505 (e.g., 505-1 shown in FIG. 7 or 505-2 shown in FIG. 8) displays image(s) (or video feed) generated by grain cameras 380. The image(s) or video feed displayed by camera display element 505 shows the grain as well as characteristics of the grain, such as the cleanliness of the grain or the brokenness of the grain, or both. In another example, camera display element 505 is an interactable camera display element (e.g., 505-3 shown in FIG. 9, 505-4 shown in FIG. 10) that, upon interaction by a user or an operator, causes interface generator 333 to generate (or surface) another display portion (e.g., 505-1 shown in FIG. 7 or 505-2 shown in FIG. 8). Camera display portion is generated by camera display generator 402.

Limit display portion 506 includes one or more limit value display elements 507. Each limit value display element 507 display a limit value for a corresponding characteristic (e.g., a grain cleanliness limit value, a grain brokenness limit value, etc.). Limit display portion 506 is generated by limit display generator 404.

Limit value adjuster display portion 508 includes one or more limit value adjuster display elements 509. Each limit value adjuster 509 corresponds to a characteristic (e.g., a grain cleanliness limit value adjuster, a grain brokenness limit value adjuster, etc.) and is interactable by a user or operator, or both, to adjust the limit value of the corresponding characteristic. The limit value displayed by each limit value display element 507 will correspondingly adjust based on the adjustment of the corresponding limit value adjuster display element 509. Limit value adjuster display portion 508 is generated by limit display generator 404.

Information display portion 510 includes one or more information display elements 511. Each information display element 511 can display information in various forms (textually, (such as words or numbers, etc.) or non-textually (such as colors, patterns, symbols, etc.), etc.) to a user or operator, or both. The information may provide description of one or more elements of the interface 448-1, may provide description the interface 448-1, and may provide a prompt for a user or operator, or both. Information display portion 510 is generated by information display generator 410.

Characteristic value display portion 513 includes one or more characteristic value display elements 514. Each characteristic value display element 514 displays a value of a corresponding grain characteristic. For example, Characteristic value display portion 513 can include, as a characteristic display element 514, a grain cleanliness value display element that displays a current (e.g., most recently detected grain cleanliness value or an average of a plurality of previously detected grain cleanliness values) cleanliness value. Additionally, or alternatively, characteristic value display portion 513 can includes, as a characteristic display element 514, a grain brokenness value display element that displays a current (e.g., most recently detected grain brokenness value or an average of a plurality of previously detected grain brokenness values) brokenness value. Additionally, or alternatively, characteristic value display portion can include, as characteristic display elements 514, other characteristic value display elements that each display a current value of another characteristic (other than grain cleanliness or grain brokenness). Characteristic value display portion is generated by characteristic value display generator 406.

Other display elements 512 can include various other display elements, such as interactable display elements. Other display elements are generated by other display generator 412.

FIG. 6B is a block diagram illustrating one example user interface 448 (illustratively shown as 448-2) generated by interface generator 333. FIG. 6B is similar to FIG. 6A and thus similar items are numbered similarly. FIG. 6A shows that grain characteristic portion 502 can be a stand-alone interface while FIG. 6B shows that grain characteristic portion 502 can be a portion of a larger interface that also includes one or more other portions that include various other display elements. As illustrated in FIG. 6B, user interface 448-2 includes grain characteristic portion 502, one or more other portions 514 that each include one or more display elements 516, and can include various other items 518.

Each other portion 514 may include one or more display elements 516 that display various other items or information, or both, that may be of interest or useable by a user or operator, or both, in the control of harvester 100.

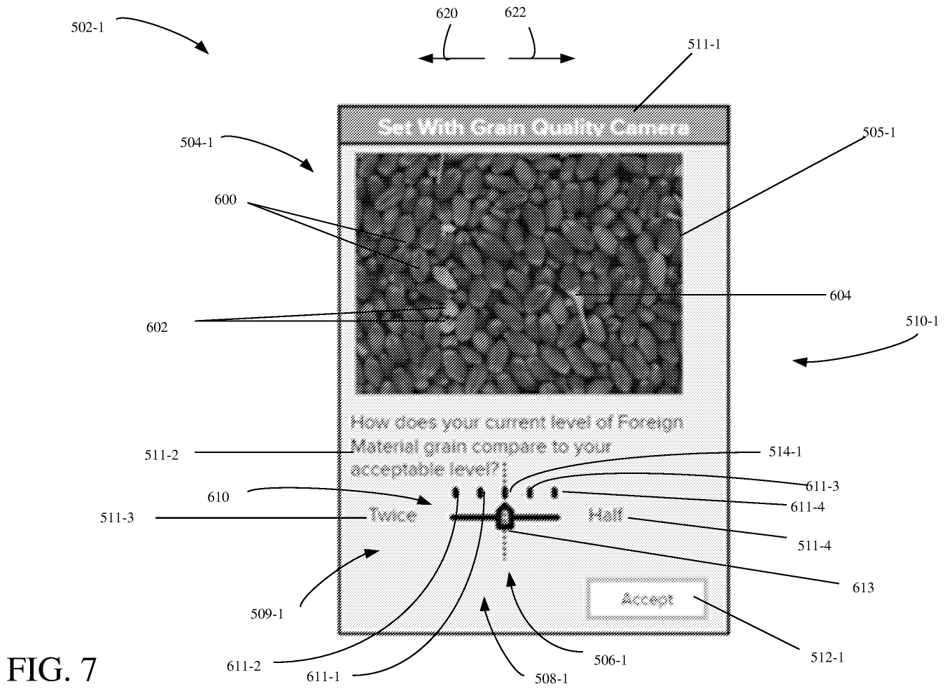

FIG. 7 is a pictorial illustration showing one example of a grain characteristic display portion 502 (illustratively shown as 502-1). Grain characteristic display portion 502-1 includes an example camera display portion 504 (illustratively shown as 504-1), an example characteristic value display portion 513 (illustratively shown as 513-1), an example limit value adjuster display portion 508 (illustratively shown as 508-1), an example information display portion 510 (illustratively shown as 510-1), and an example other item 512 (illustratively shown as 512-1).

Camera display portion 504-1 includes an example camera display element 505 (illustratively shown as 505-1). Camera display element 505-1 shows image(s) (or a video feed) generated by grain cameras 380. Grain camera display element 505-1 shows grain 600 as well as grain characteristics, for example, broken grain 602 is shown in the display element by way of visually distinguishing the broken grain by adding a color overlay over each broken grain and grain cleanliness is shown in the display element by showing MOG (or foreign material) 604 included with the grain 600 by adding a color overlay (of a different color than the broken grain color overlay) over each item of MOG. While color is described and shown as one example of displaying the grain characteristics, in other examples the grain characteristics can be displayed in various other ways.

Characteristic value display portion 513-1 includes an example characteristic value display element 514 (illustratively shown as 514-1). Characteristic value display element 514-1 is a mark incorporated into the limit value adjuster display element 509-1 (described below). Specifically, the characteristic value display element 514-1 is a mark incorporated into the scale 610 (described below) of the limit value adjuster display element 509-1. Characteristic value display element 514-1 indicates the current limit value of the corresponding characteristic (in the example of FIG. 7 the characteristic is grain cleanliness, as indicated by information display element 511-2, but could be grain brokenness in other examples).

Limit value adjuster display portion 508-1 includes an example limit value adjuster display element 509-1 that is interactable by a user or an operator, or both. Limit value adjuster display element 509-1 includes a scale 610 that includes a plurality of incremental value display elements 611 (illustratively shown as 611-1, 611-2, 611-3, and 611-4), as well as the characteristic value display element 514-1, as described above. Incremental value display elements 611 are marks on the scale 610. Limit value adjuster display element 509-1 further includes a slider 613 that is moveable (e.g., by user or operator interaction) along the scale 610 in either a first direction indicated by arrow 620 (hereinafter referred to as direction 620) or a second direction indicated by arrow 622 (hereinafter referred to as direction 622) to an incremental value display element 611 to adjust the corresponding limit value.

As illustrated in FIG. 7, moving the slider 613 in the direction 620 will adjust the current limit value incrementally and relative to the current characteristic value indicated by 514-1 (e.g., adjust to 50% over the current characteristic value by moving to incremental limit value display element 611-1 or adjust to 100% by moving incremental limit value display element 611-2). Thus, moving the slider 613 in the direction 620 to incremental limit value display element 611-1 will subsequently allow for 50% more MOG intake (or in the case of broken grain 50% more broken grain) than the current MOG intake (or in the case of broken grain, than the current broken grain) indicated by characteristic value display element 514-1. Further, moving the slider 613 in the direction 620 to incremental limit value display element 611-2 will subsequently allow for 100% more (or twice as much) MOG intake (or in the case of broken grain 100% more or twice as much broken grain) than the current MOG intake (or in the case of broken grain, than the current broken grain) indicated by characteristic value display element 514-1.

As illustrated in FIG. 7, moving the slider 613 in the direction 622 will adjust the current limit value incrementally and relative to the current characteristic value indicated by 514-1 (e.g., adjust to 25% less than the current characteristic value by moving to incremental limit value display element 611-3 or adjust to 50% less than the current characteristic value by moving to incremental limit value display element 611-4). Thus, moving the slider 613 in the direction 622 to incremental limit value display element 611-3 will subsequently allow for 25% less MOG intake (or in the case of broken grain 25% less broken grain) than the current MOG intake (or in the case of broken grain, than the current broken grain) indicated by characteristic value display element 514-1 and moving the slider 613 in the direction 622 to incremental limit value display element 611-4 will subsequently allow for 50% less (or half as much) MOG intake (or in the case of broken grain 50% less or half as much broken grain) than the current MOG intake (or in the case of broken grain, than the current broken grain) indicated by characteristic value display element 514-1.

As shown in FIG. 7, information display portion 510-1 includes example information display elements 511 (illustratively shown as 511-1, 511-2, 511-3, and 511-4). Information display element 511-1 provides textual description of the grain characteristic display portion 502-1. Information display element 511-2 provides a textual prompt that prompts a user to interact with limit value adjuster display element 509-1. Information display elements 511-3 and 511-4 each provide textual description of the values of the scale 610.

As shown in FIG. 7, other item 512-1 is an interactable display element that allows for user or operator interaction to set (or “accept”) the limit value as displayed or as adjusted.

It will be noted that while the example grain characteristic display portion 502-1 shown in FIG. 7 corresponds to grain cleanliness (or MOG/foreign material) interface generator 333 is operable to generate another example grain characteristic display portion, similar to grain characteristic display portion 502-1, that corresponds to grain brokenness (or broken grain). In such an example, one or more elements, such as information element 511-2, would change to reflect that the display portion corresponds to grain brokenness.

FIG. 8 is a pictorial illustration showing one example grain characteristic portion 502 (illustratively shown as 502-2) generated by interface generator 333. Grain characteristic display portion 502-2 includes an example camera display portion 504 (illustratively shown as 504-2), an example limit display portion 506 (illustratively shown as 506-1), an example limit value adjuster display portion 508 (illustratively shown as 508-2), an example information display portion 510 (illustratively shown as 510-2), an example characteristic display portion 513 (illustratively shown as 513-2) and example other items 512 (illustratively shown as 512-2, 512-3, 512-4, and 512-3).

Camera display portion 504-2 includes an example camera display element 505 (illustratively shown as 505-2). Camera display element 505-2 is similar to camera display element 505-1.

Limit display portion 506-1 includes a first example limit value display element 507 (illustratively shown as 507-1), a second example limit value display element 507 (illustratively shown as 507-2), a third example limit value display element 507 (illustratively shown as 507-5), and a fourth example limit value display element 507 (illustratively shown as 507-6. Limit value display element 507-1 and limit value display element 507-5, in the illustrated example, correspond to a grain cleanliness (or MOG/foreign material) limit. Limit value display element 507-2 and limit value display element 507-6, in the illustrated example, correspond to a grain brokenness (or broken grain) limit.

Limit value display element 507-1 is a mark incorporated into the limit value adjuster display element 509-2 (described below). Specifically, limit value display element 507-1 is a mark incorporated into the scale 650 (described below). Limit value display element 507-2 is a mark incorporated into the limit value adjuster display element 509-3 (described below). Specifically, limit value display element 507-2 is a mark incorporated into the scale 660 (described below). Both limit value display element 507-1 and limit value display element 507-2 indicate the current limit value of their corresponding characteristic (grain cleanliness and grain brokenness, respectively).

Limit value display element 507-5 is a display element that provides a textual description (a textual value in the form of a number) of the grain cleanliness (or MOG/foreign material) limit. Limit value display element 507-6 is a display element that provides a textual description (a textual value in the form of a number) of the grain brokenness (or broken grain) limit. Both limit value display element 507-5 and limit value display element 507-6 indicate the current limit value of their corresponding characteristic (grain cleanliness and grain brokenness, respectively).

Limit value adjuster display portion 508-2 includes an example first limit value adjuster display element 509-2 that is interactable by a user or an operator, or both, and an example second limit value adjuster display element 509-3 that is interactable by a user or an operator, or both. Limit value adjuster display element 509-2 includes a scale 650 that includes a plurality of incremental value display elements 651, slider 653, interactable adjuster elements 655 (illustratively shown as 655-1 and 655-2), as well as the limit value display element 507-1, as described above. Incremental value display elements 651 are marks on the scale 650. Slider 653 is movable by way of user or operator interaction with adjuster elements 655, to move along the scale 650 in either a first direction indicated by arrow 630 (hereinafter referred to as direction 630) or a second direction indicated by arrow 632 (hereinafter referred to as direction 632) to an incremental value display element 651 to adjust the corresponding limit value. Limit value adjuster display element 509-3 includes a scale 660 that includes a plurality of incremental value display elements 661, a slider 663, interactable adjuster elements 665 (illustratively shown as 665-1 and 665-2), as well as the limit value display element 507-2, as described above. Incremental value display elements 661 are marks on the scale 660. Slider 663 is moveable by way of user or operator interaction with adjuster elements 665, to move along the scale 660 in either in direction 630 or in direction 632 to an incremental value display element 661 to adjust the corresponding limit value.

As illustrated in FIG. 8, moving the slider 653 in the direction 630 will incrementally decrease (decreasing more for each subsequent incremental value display element 651 in the direction 630) the current grain cleanliness (or MOG/foreign material) limit value. Moving the slider 663 in the direction 630 will incrementally decrease (decreasing more for each subsequent incremental value display element 661 in the direction 630) the current grain brokenness (or broken grain) limit value.

As illustrated in FIG. 8, moving the slider 653 in the direction 632 will incrementally increase (increasing more for each subsequent incremental value display element 651 in the direction 632) the current grain cleanliness (or MOG/foreign material) limit value. Moving the slider 663 in the direction 632 will incrementally increasing (increasing more for each subsequent incremental value display element 661 in the direction 632) the current grain brokenness (or broken grain) limit value.

As shown in FIG. 8, interaction with adjuster element 655-1 will cause the slider 653 to move in the direction 630. Interaction with adjuster display element 665-1 will cause the slider 663 to move in the direction 630. Interaction with adjuster display element 655-2 will cause the slider 653 to move in the direction 632. Interaction with adjuster display element 665-2 will cause the slider 663 to move in the direction 632.

Grain characteristic value display portion 513-2 includes grain characteristic value display elements 514-2 and 514-3. Grain characteristic value display element 514-2 is a grain cleanliness value display element that displays a current grain cleanliness value. Grain characteristic value display element 514-3 is a grain brokenness value display element that displays a current grain brokenness value.

As shown in FIG. 8, information display portion 510-1 includes example information display elements 511 (illustratively shown as 511-5, 511-6, 511-7, 511-8, 511-9, 511-10, 511-11, 511-12, and 511-13). Information display element 511-5 provides textual description of the grain characteristic display portion 502-2. Information display element 511-6 provides a textual description of the camera display element 505-2. Information display element 511-7 provides a textual description of characteristic value display elements 514-2 and 514-3. Information display element 511-8 provides a prompt that prompts a user or operator, or both, to interact with limit value adjuster display element 509-2. Information display element 511-9 provides a prompt that prompts a user to interact with limit value adjuster display element 509-3.

Information display elements 511-10 provide non-textual description (in the form of MOG/foreign material symbols) describing that interaction with adjuster display element 655-1 will reduce the grain cleanliness (or MOG/foreign material) limit and that interaction with display element 655-2 will increase the grain cleanliness (or MOG/foreign material) limit. Information display elements 511-11 provide non-textual description (in the form of broken grain symbols) describing that interaction with adjuster display element 665-1 will reduce the grain brokenness (or broken grain) limit and that interaction with display element 665-2 will increase the grain brokenness (or broken grain) limit.

Information display element 511-12 is a color gradient that cooperates with a characteristic value display element (grain cleanliness value display element) 514-2. The grain characteristic value display element 514-2 is placed at a position along the color gradient 511-12 and is associated with a color on the color gradient 511-12 to visually indicate the severity or extent of the deviation between the grain cleanliness value and the grain cleanliness limit. The color gradient 511-12 is aligned with scale 650. That is, the color gradient 511-12 is of the same length as scale 650 and its ends line up with the ends of scale 650. Information display element 511-13 is a color gradient that cooperates with characteristic value display element (grain brokenness value display element) 514-3. The grain characteristic value display element 514-3 is placed at a position along the color gradient 511-13 and is associated with a color on the color gradient 511-13 to visually indicate the severity or extent of the deviation between the grain brokenness value and the grain brokenness limit. The color gradient 511-13 is aligned with scale 660. That is, the color gradient 511-13 is of the same length as scale 650 and its ends line up with the ends of scale 660.

As shown in FIG. 8, other item 512-2 is an interactable display element that allows for user or operator interaction to set (or “save”) the limit value(s) as displayed or as adjusted. Other item 512-3 is an interactable display element that allows for user or operator interaction to cancel adjustments to the limit value(s). Other item 512-4 is an interactable display element that allows for user or operator interaction to leave grain characteristic display portion 502-2. Other item 512-13 is an interactable display element that, upon user or operator interaction, will cause interface generator 333 to generate (or surface) another display portion that provides help to the operator or user.

FIG. 9 is a pictorial illustration showing one example grain characteristic display portion 502 (illustratively shown as 502-3). Grain characteristic display portion 502-3 includes an example camera display portion 504 (illustratively shown as 504-3), an example limit display portion 506 (illustratively shown as 506-2), an example limit value adjuster display portion 508 (illustratively shown as 508-3), an example information display portion 510 (illustratively shown as 510-3), and example other items 512 (illustratively shown as 512-5, 512-6, 512-7, and 512-8). In other examples, it will be understood that grain characteristic display portion 502-3 can include a characteristic value display portion 513 (e.g., similar to 513-2) that includes a characteristic value display element 514 (e.g., similar to 514-2).

Camera display portion 504-3 includes an example camera display element 505 (illustratively shown as 505-3). Camera display element 505-3 is an interactable display element that upon user or operator interaction will cause interface generator 333 to generate (or surface) another display portion such as display portion 502-1 or display portion 502-2.

Limit display portion 506-2 includes a first example limit value display element 507 (illustratively 507-3) and a second example limit value display element 507 (illustratively shown as 507-7). Limit value display element 507-3 is a mark incorporated into the limit value adjuster display element 509-4 (described below). Specifically, limit value display element 507-3 is a mark incorporated into the scale 670 (described below). Limit value display element 507-3 indicates the current limit value of its corresponding characteristic (grain cleanliness in the illustrated example). Limit value display element 507-7 is a display element that provides a textual description (a textual value in the form of a number) of the grain cleanliness (or MOG/foreign material) limit.

Limit value adjuster display portion 508-4 includes an example limit value adjuster display element 509-4 that is interactable by a user or operator, or both. Limit value adjuster display element 509-4 includes a scale 670 that includes a plurality of incremental display elements 671, a slider 673, interactable adjuster elements 675 (illustratively shown as 675-1 and 675-2), as well as limit value display element 507-3, as described above. Incremental value display elements 671 are marks on the scale 670. Slider 673 is moveable by way of operator or user interaction with adjuster elements 675, along scale 670 in either a first direction indicated by arrow 640 (hereinafter direction 640) or a second direction indicated by arrow 642 (hereinafter direction 642) to an incremental value display element 671 to adjust the corresponding limit value.

As illustrated in FIG. 9, moving the slider 673 in the direction 640, by way of interaction with interactable adjuster element 675-1, will incrementally decrease (decreasing more for each subsequent incremental value display element 671 in the direction 640) the current grain cleanliness (or MOG/foreign material) limit value. Moving the slider 673 in the direction 642, by way of interaction with interactable adjuster element 675-2, will incrementally increase (increasing more for each subsequent incremental value display element 671 in the direction 642) the current grain cleanliness limit value.

As shown in FIG. 9, information display portion 510-3 includes example information display elements 511-18, 511-19, 511-20, 511-21, 511-22, 511-23, 511-24, and 511-25). Information display element 511-18 provides a textual description of the grain characteristic display portion 502-3. Information display element 511-19 provides a prompt that prompts a user or operator, or both, to interact with limit value adjuster display element 509-4. Information display element 511-20 provides a textual description of grain characteristic display portion 502-3 and a prompt to prompt a user or operator, or both, to interact with camera display element 505-3. Information display element 511-21 provides non-textual description (in the form of a MOG/foreign material symbol) to describe limit value adjuster display element 509-4. Information display element 511-22 provides a textual description that describes a recommended grain cleanliness limit generated by control determination system 336. Information display element 511-23 provides textual description describing that interaction with adjuster display element 675-1 will reduce the grain cleanliness limit. Information display element 511-24 provides textual description describing that interaction with adjuster display element 675-2 will increase the grain cleanliness limit. Information display element 511-25 is a color gradient similar to color gradients 511-12 and 511-13.

As shown in FIG. 9, other item 512-5 is an interactable display element that allows for user or operator interaction to set (or “save”) the limit value as displayed or as adjusted. Other item 512-6 is an interactable display element that allows for user or operator interaction to cancel adjustments to the limit value. Other item 512-7 is an interactable display element that allows for user or operator interaction to leave grain characteristic display portion 502-3. Other item 512-8 is an interactable display element that, upon user or operator interaction, will cause interface generator 333 to generate (or surface) another display portion that provides help to the operator or user.

FIG. 10 is a pictorial illustration showing one example grain characteristic display portion 502 (illustratively shown as 502-4). Grain characteristic display portion 502-4 includes an example camera display portion 504 (illustratively shown as 504-4), an example limit display portion 506 (illustratively shown as 506-3), an example limit value adjuster display portion 508 (illustratively shown as 508-4), an example information display portion 510 (illustratively shown as 510-4), and example other items 512 (illustratively shown as 512-9, 512-10, 512-11, and 512-12). In other examples, it will be understood that grain characteristic display portion 502-4 can include a characteristic value display portion 513 (e.g., similar to 513-2) that includes a characteristic value display element 514 (e.g., similar to 514-3).

Camera display portion 504-4 includes an example camera display element 505 (illustratively shown as 505-4). Camera display element 505-4 is an interactable display element that upon user or operator interaction will cause interface generator 333 to generate (or surface) another display portion such as display portion similar to display portion 502-1 (except corresponding to grain brokenness) or display portion 502-2.

Limit display portion 506-3 includes a first example limit value display element 507 (illustratively 507-4) and a second example limit value display element 507 (illustratively 507-8). Limit value display element 507-4 is a mark incorporated into the limit value adjuster display element 509-5 (described below). Specifically, limit value display element 507-4 is a mark incorporated into the scale 680 (described below). Limit value display element 507-4 indicates the current limit value of its corresponding characteristic (grain brokenness in the illustrated example). Limit value display element 507-8 is a display element that provides a textual description (a textual value in the form of a number) of the grain brokenness (or broken grain) limit.

Limit value adjuster display portion 508-4 includes an example limit value adjuster display element 509-5 that is interactable by a user or operator, or both. Limit value adjuster display element 509-5 includes a scale 680 that includes a plurality of incremental display elements 681, a slider 683, interactable adjuster elements 685 (illustratively shown as 685-1 and 685-2), as well as limit value display element 507-4, as described above. Incremental value display elements 681 are marks on the scale 680. Slider 683 is moveable by way of operator or user interaction with adjuster elements 685, along scale 680 in either a first direction indicated by arrow 644 (hereinafter direction 644) or a second direction indicated by arrow 646 (hereinafter direction 646) to an incremental value display clement 681 to adjust the corresponding limit value.

As illustrated in FIG. 10, moving the slider 683 in the direction 644, by way of interaction with interactable adjuster element 685-1, will incrementally decrease (decreasing more for each subsequent incremental value display element 681 in the direction 644) the current grain brokenness (or broken grain) limit value. Moving the slider 683 in the direction 646, by way of interaction with interactable adjuster element 685-2, will incrementally increase (increasing more for each subsequent incremental value display element 681 in the direction 646) the current grain brokenness limit value.

As shown in FIG. 10, information display portion 510-4 includes example information display elements 511-27, 511-28, 511-29, 511-30, 511-31, 511-32, 511-33, and 511-34). Information display element 511-27 provides a textual description of the grain characteristic display portion 502-4. Information display element 511-28 provides a prompt that prompts a user or operator, or both, to interact with limit value adjuster display element 509-5. Information display element 511-29 provides a textual description of grain characteristic display portion 502-4 and a prompt to prompt a user or operator, or both, to interact with camera display element 505-4. Information display element 511-30 provides non-textual description (in the form of a broken grain symbol) to describe limit value adjuster display element 509-5. Information display element 511-31 provides a textual description that describes a recommended grain brokenness limit generated by control determination system 336. Information display element 511-32 provides textual description describing that interaction with adjuster display element 685-1 will reduce the grain brokenness limit. Information display element 511-33 provides textual description describing that interaction with adjuster display element 685-2 will increase the grain brokenness limit. Information display element 511-34 is a color gradient.

As shown in FIG. 10, other item 512-9 is an interactable display element that allows for user or operator interaction to set (or “save”) the limit value as displayed or as adjusted. Other item 512-10 is an interactable display element that allows for user or operator interaction to cancel adjustments to the limit value. Other item 512-11 is an interactable display element that allows for user or operator interaction to leave grain characteristic display portion 502-4. Other item 512-12 is an interactable display clement that, upon user or operator interaction, will cause interface generator 333 to generate (or surface) another display portion that provides help to the operator or user.

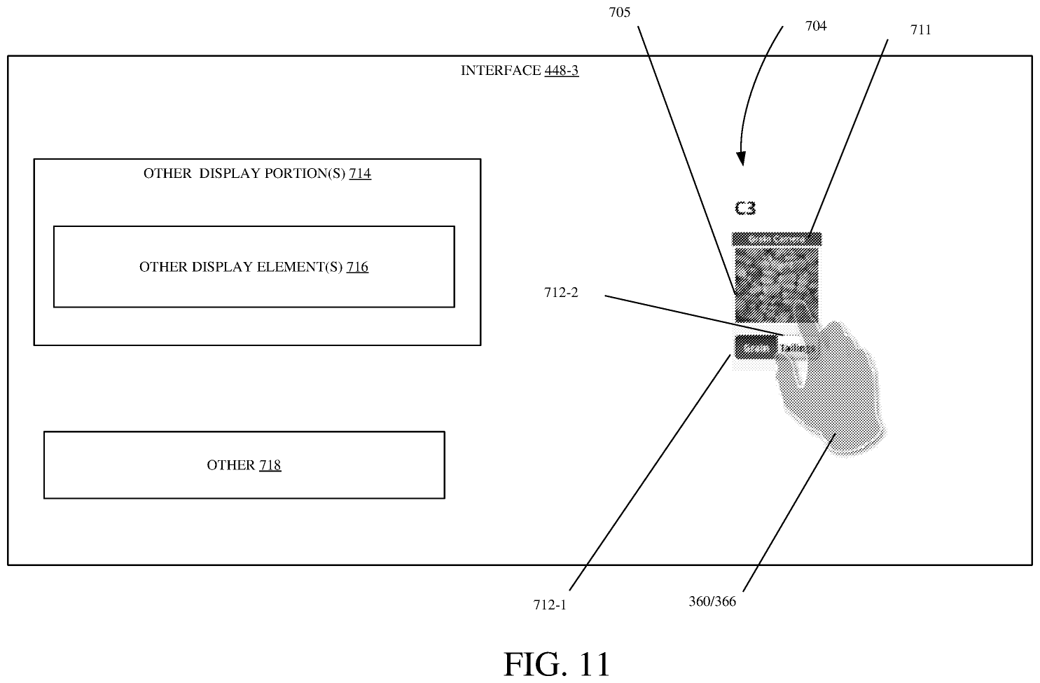

FIG. 11 is a partial pictorial illustration and partial block diagram that shows one example interface 448 (illustratively shown as interface 448-3) generated by interface generator 333. Interface 448-3 includes camera display portion 704, one or more other display portions 714, and can include various other items 718 as well. Camera display portion 704, itself, includes camera display element 705, information display element 711, and other items 712-1 and 712-2. Other display portions 714 include one or more other display elements 716 that display various other items or information, or both, that may be of interest or useable by a user or operator, or both, in the control of harvester 100.

Camera display element 705 is an interactable display element. Camera display element 705 shows image(s) (or a video feed) generated by grain cameras 380. Additionally, camera display element 705 can show image(s) (or a video feed) generated by other sensors, such as image(s) (or a video feed) generated by an observation sensor system 151.

As illustrated in FIG. 11, information display element 711 provides textual description of camera display element 705.

As shown in FIG. 11, other items 712-1 and 712-2 are interactable display elements that allow user or operator interaction to switch the camera display element 705 between showing image(s) (or a video feed) generated by grain cameras 380 and showing image(s) (or a video feed) generated by other sensors, such as image(s) (or a video feed) generated by an observation sensor system 151 disposed to view tailings exiting harvester 100 or an observation system 151 disposed to view tailings being transported by tailings elevator 128. As illustrated, other item 712-1 is interactable to allow a user or operator, or both, to select display of image(s) (or a video feed) generated by grain cameras 380. In the illustrated example, other item 712-1 is currently selected. Further, as illustrated, other item 712-2 is interactable to allow a user or operator, or both, to select 11 display of image(s) (or a video feed) generated by an observation sensor system 151 disposed to view tailings exiting harvester 100 or an observation system 151 disposed to view tailings being transported by tailings elevator 128.

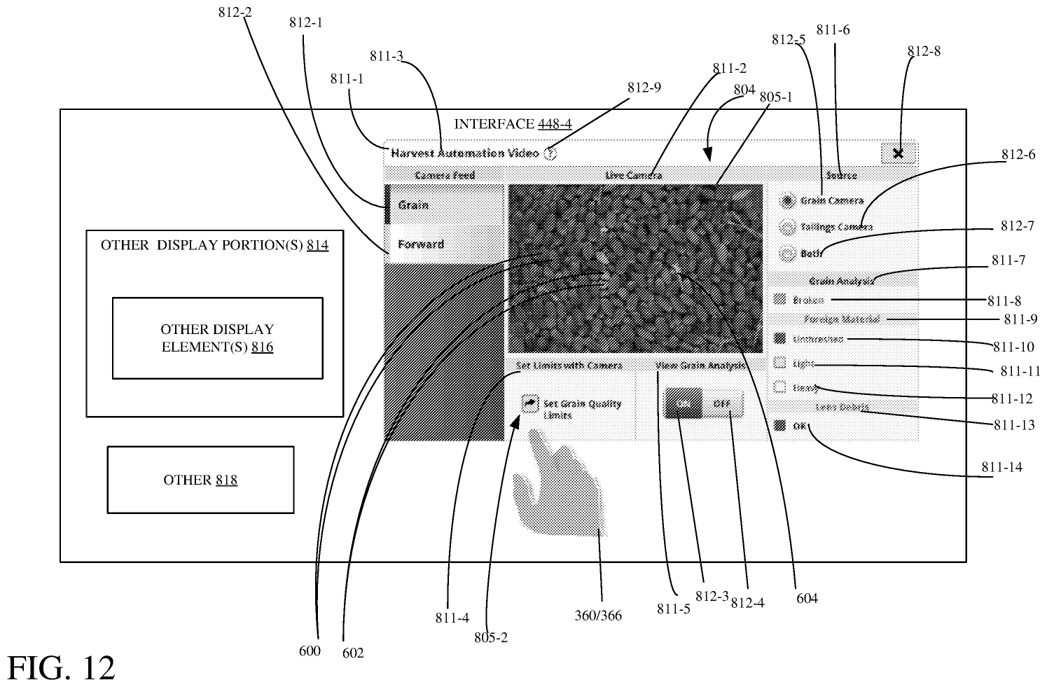

FIG. 11 also shows an operator 360 or user 366 interacting with camera display element 705. Interaction with camera display element 705 causes interface generator 333 to generate (or surface) another user interface 448 (e.g., 448-4 shown in FIG. 12).

FIG. 12 is a partial pictorial illustration and partial block diagram that shows one example interface 448 (illustratively shown as interface 448-4) generated by interface generator 333. Interface 448-4 includes grain characteristic display portion 802, one or more other display portions 814, and can include various other items 818 as well.

Grain characteristic display portion 802, itself, includes camera display portion 804. Camera display portion 804 includes camera display element 805-1, camera display element 805-2, information display element 811-2, information display element 811-4, information display element 811-5, other item 812-3, and other item 812-4. Grain characteristic display portion 802. itself, further includes a plurality of information display element 811 (illustratively shown as 811-1, 811-3, 811-6, 811-7, 811-8, 811-9, 811-10, 811-11, 811-12, 811-13, and 811-14), and a plurality of other items 812 (illustratively shown as 812-1 through 812-9).

Camera display element 805-1 shows image(s) (or a video feed) generated by grain cameras 380. Additionally, camera display element 705 can show image(s) (or a video feed) generated by other sensors, such as image(s) (or a video feed) generated by an observation sensor system 151.

As illustrated, other items 812-1 and 812-2 are interactable display elements that allow user or operator interaction to switch the camera display element 805-1 between showing image(s) (or a video feed) generated by grain cameras 380 or image(s) (or a video feed) generated by other sensors, such as an observation system 151 disposed to view tailings exiting harvester 100 or an observation system 151 disposed to view tailings being transported by tailings elevator 128 and showing image(s) (or a video feed) generated by other sensors, such as image(s) (or a video feed) generated by an observation sensor system 151 disposed to view forward of the harvester 100, relative to the direction of travel 147 of harvester 100. As illustrated, other item 812-1 is interactable to allow a user or operator, or both, to select display of image(s) (or a video feed) generated by grain cameras 380 or image(s) (or a video feed) generated by an observation system 151 disposed to view tailings exiting harvester 100 or an observation system 151 disposed to view tailings being transported by tailings elevator 128. In the illustrated example, other item 812-1 is currently selected.

Other items 812-5, 812-6, and 812-7 are interactable display elements that allow user or operator interaction to control the camera display element 805-1 to show image(s) (or a video feed) generated by grain cameras 380 or image(s) (or a video feed) generated by other sensors, such as an observation system 151 disposed to view tailings exiting harvester 100 or an observation system 151 disposed to view tailings being transported by tailings elevator 128, or both. As illustrated, other item 812-5 is interactable to allow a user or operator, or both, to select display of image(s) (or a video feed) generated by cameras 380. Other item 812-6 is interactable to allow a user or operator, or both, to select display of image(s) (or a video feed) generated by an observation system 151 disposed to view tailings exiting harvester 100 or an observation system 151 disposed to view tailings being transported by tailings elevator 128. Other item 812-7 is interactable to allow a user or operator, or both, to select simultaneous display of image(s) (or a video feed) generated by grain cameras 380 and of image(s) (or a video feed) generated by an observation system 151 disposed to view tailings exiting harvester 100 or an observation system 151 disposed to view tailings being transported by tailings elevator 128. In the illustrated example, other item 812-5 is currently selected.

Further, as illustrated, other item 812-2 is interactable to allow a user or operator, or both, to select display of image(s) (or a video feed) generated by an observation sensor system 151 disposed to view forward of the harvester 100.

As illustrated, camera display element 805-1 shows grain 600 as well as grain characteristics, for example, broken grain 602 is shown in the display element by way of visually distinguishing the broken grain by adding a color overlay over each broken grain and grain cleanliness is shown in the display element by showing MOG (or foreign material) 604 included with the grain 600 by adding a color overlay (of a different color than the broken grain color overlay) over each item of MOG. While color is described and shown as one example of displaying the grain characteristics, in other examples the grain characteristics can be displayed in various other ways.

As illustrated in FIG. 12, information display elements 811-8, 811-10, 811-11, and 811-12 provide textual and non-textual description of grain characteristics shown in camera display element 805-1. As shown, information display element 811-8 provides textual description of the corresponding grain characteristic (grain brokenness or broke grain) as well as non-textual description describing the color overlay used to highlight broken grain in the camera display element 805-1. As shown, information display element 811-10 provides textual description of the corresponding grain characteristic (grain cleanliness or MOG/foreign material), and specifically, a quality of the grain characteristic (unthreshed MOG/foreign material), as well as non-textual description describing the color overlay used to highlight unthreshed MOG/foreign material (or grain cleanliness) in the camera display element 805-1. As shown, information display element 811-11 provides textual description of the corresponding grain characteristic (grain cleanliness or MOG/foreign material), and specifically, a quality of the grain characteristic (light MOG/foreign material), as well as non-textual description describing the color overlay used to highlight light MOG/foreign material (or grain cleanliness) in the camera display element 805-1. As shown, information display element 811-12 provides textual description of the corresponding grain characteristic (grain cleanliness or MOG/foreign material), and specifically, a quality of the grain characteristic (heavy MOG/foreign material), as well as non-textual description describing the color overlay used to highlight heavy MOG/foreign material (or grain cleanliness) in the camera display element 805-1. It will be understood that heavy and light, as shown herein, are used to differentiate between MOG material that can be blown out by the cleaning fan 120 (e.g., light material) and MOG material that cannot be (or cannot easily be) blown out by the cleaning fan 120 (e.g., heavy material).

Camera display element 805-2 is an interactable display element that upon user or operator interaction will cause interface generator 333 to generate (or surface) another interface 448 (e.g., 448-1 or 448-2) that includes a grain characteristic display portion 502 (e.g., 502-1, 502-2, 502-3, or 502-4). As illustrated in FIG. 12, an operator 360 or user 366 is seen interacting with camera display element 805-2.

Other items 812-3 and 812-4 are interactable display elements that allow operator or user interaction to switch on and off the visual distinction functionality of the camera display element 705-1. Specially, other item 812-3 (shown as currently selected in FIG. 12) is interactable to allow a user or operator, or both, to select display of visual distinction (e.g., color overlays) of grain characteristics in camera display element 705-1. Other item 812-4 is interactable to allow a user or operator, or both, to turn off (or disable) display of visual distinction (e.g., color overlays) of grain characteristic in camera display element 705-1.

Other item 812-8 is an interactable display element that allows for user or operator interaction to leave user interface 448-4. Other item 812-9 is an interactable display element that, upon user or operator interaction, will cause interface generator 333 to generate (or surface) another display portion that provides help to the operator or user. In some examples, rather than only 812-9 being interactable, the entire bar on which 812-9 sits (save for the space dedicated to 812-8) is interactable to cause interface generator 333 to generate (or surface) another display portion that provides help to the operator or user.

Information display element 811-1 provides textual description of grain characteristic display portion 802. Information display element 811-2 provides textual description of camera display element 805-1. Information display element 811-3 provides textual description of other items 812-1 and 812-2 and/or a prompt to interact with other items 812-1 and 812-2. Information display element 811-4 provides textual description of camera display element 805-2 and a prompt to interact with camera display element 805-2. Information display element 811-5 provides textual description of other items 812-3 and 812-4 and/or a prompt to interact with other items 812-3 and 812-4. Information display element 811-6 provides textual description of other items 812-5, 812-6, and 812-7 and/or a prompt to interact with other items 812-5, 812-6, and 812-7. Information display element 811-7 provides textual description of information display element 811-8. Information display element 811-9 provides textual description of information display elements 811-10, 811-11, and 811-12. Information display element 811-14 provides textual and non-textual description of indicative of a cleanliness (e.g., level of debris) on a lens of a camera providing the image(s) (or video feed) used in camera display element 805-1. As illustrated, the textual description of information display element 811-14 can include words such as “OK” as well as various other words (e.g., good, clean, dirty, etc.) to indicate the level of cleanliness of the camera lens. As illustrated the non-textual description of information display element 811-14 can include color (e.g., red, yellow, green, etc.) to indicate the level of cleanliness of the camera lens. Information display element 811-3 provides textual description of information display element 811-14.

It will be noted that while the various examples shown herein illustrate the various display elements in example form, the various display elements can be, in other example, in a different form. For instance, while a display element may be shown in an example as providing textual description or displaying information textually, in other examples, such a display element could provide nontextual description or provide information in nontextual form. Similarly, while a display clement may be shown in an example as providing nontextual description or displaying information nontextually, in other examples, such a display clement could provide textual description or provide information in textual form.

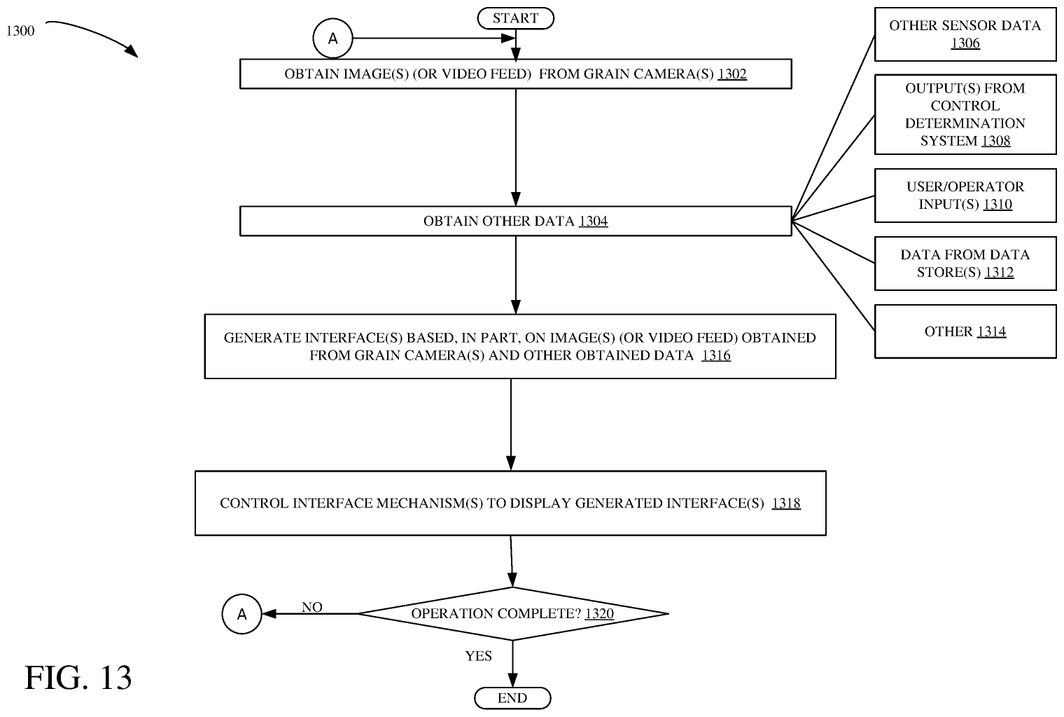

FIG. 13 shows a flow diagram illustrating one example operation 1300 of agricultural harvesting system architecture 300 in generating one or more interfaces 448.

It is first assumed that harvester 100 is powered on and operating at a field. However, in some examples, operation 1300 can also occur prior to or after operation at a field.

At block 1302, one or more images or a video feed is obtained from one or more grain cameras 380.

At block 1304, one or more other items of data are obtained. For example, at block 1306, other sensor data from various other sensors can be obtained, including any of the other sensors described herein. At block 1308 one or more outputs 458 generated by control determination system 336 can be obtained. At block 1310 one or more inputs from a user 366 or an operator 360, or both, can be obtained. At block 1312 data from one or more data stores 302 can be obtained. At block 1314 various other data, such as other data 446, can be obtained.

At block 1316 interface generator 333 generates one or more interfaces 448 (e.g., one or more of 448-1, 448-2, 448-3, or 448-4) based on the image(s) (or video feed) from grain cameras 380 and based on one or more other items of data obtained at block 1304.

At block 1318 interface controller 330 generates one or more control signals to control one or more interface mechanisms (e.g., 318 or 364, or both) to display the one or more interfaces 448 generated by interface generator 333.

At block 1320 it is determined if operation 1300 has been completed. If, at block 1320, it is determined that operation 1300 has not been completed, then processing returns to block 1302. If, at block 1320, it is determined that operation 1300 has been completed, then processing ends.

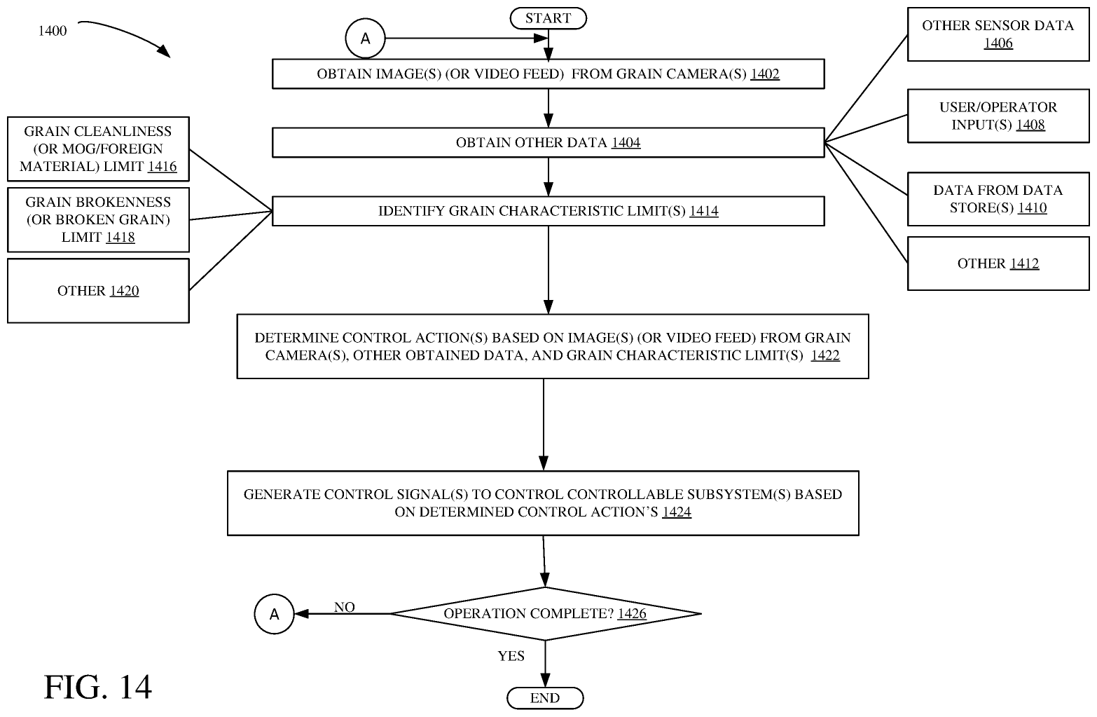

FIG. 14 shows a flow diagram illustrating one example operation 1400 of agricultural harvesting system architecture 300 in controlling harvester 100. It is first assumed that harvester is powered on and operating at a field. However, in some examples, operation 1400 can occur prior to or after operation at the field.

At block 1402, one or more images or a video feed is obtained from one or more grain cameras 380.

At block 1404, one or more other items of data are obtained. For example, at block 1306, other sensor data 1406 from various other sensors can be obtained, including any of the other sensors described herein. At block 1408 one or more inputs from a user 366 or an operator 360, or both, can be obtained. At block 1410 data from one or more data stores 302 can be obtained. At block 1412 various other data, such as other data 446, can be obtained.

At block 1406, control determination system 336 identifies a limit of each one of one or more grain characteristics based on one or more of the one or more other items of data obtained at block 1404. For example, at block 1416, control determination system 336 identifies a grain cleanliness (or MOG/foreign material) limit. At block 1418, control determination system 336 identifies a grain brokenness (or broken grain) limit. At block 1420, control determination system 336 identifies a limit for each one of one or more other grain characteristics.

At block 1422, control determination system 336 determines and generates as one or more outputs 458, control actions based on the image(s) (or video feed) obtained from one or more grain cameras 380, one or more of the other items of data obtained at block 1404, and the one or more identified grain characteristic limits.

At block 1424, one or more subsystem controllers 335 generate one or more control signals to control one or more controllable subsystems 316 based on the one or more control action outputs 458 generated by control determination system 336.

At block 1426 it is determined if operation 1400 has been completed. If, at block 1426, it is determined that operation 1400 has not been completed, then processing returns to block 1402. If, at block 1426, it is determined that operation 1400 has been completed, then processing ends.

The term display element is used throughout. It will be understood that display elements are visible elements (or components) of interface(s). Sometimes, display elements can also be referred to as interface display elements (or interface elements). Display elements are generated (e.g., computer generated) and are included as parts of an interface and can display various information in various forms and/or can be interactable to provide or facilitate various functionality. Display elements can include, for example, graphics, text (words, letters, numbers, etc.), fields, symbols or icons, colors, charts, graphs, tables, images (static images or video images), checkboxes, buttons, lists, toggles, sliders, bars, dropdowns, tags, scales, boxes, breadcrumbs, menus, links, accordions, carousels, pickers, cards, tooltips, widgets, notifications, steppers, tabs, windows, portions of a display, or other aspects of a display.

The present discussion has mentioned processors and servers. In some examples, the processors and servers include computer processors with associated memory and timing circuitry, not separately shown. They are functional parts of the systems or devices to which they belong and are activated by and facilitate the functionality of the other components or items in those systems.

Also, a number of user interface displays have been discussed. The displays can take a wide variety of different forms and can have a wide variety of different user actuatable operator interface mechanisms disposed thereon. For instance, user actuatable operator interface mechanisms may include text boxes, check boxes, icons, links, drop-down menus, search boxes, etc. The user actuatable operator interface mechanisms can also be actuated in a wide variety of different ways. For instance, they can be actuated using operator interface mechanisms such as a point and click device, such as a track ball or mouse, hardware buttons, switches, a joystick or keyboard, thumb switches or thumb pads, etc., a virtual keyboard or other virtual actuators. In addition, where the screen on which the user actuatable operator interface mechanisms are displayed is a touch sensitive screen, the user actuatable operator interface mechanisms can be actuated using touch gestures. Also, user actuatable operator interface mechanisms can be actuated using speech commands using speech recognition functionality. Speech recognition may be implemented using a speech detection device, such as a microphone, and software that functions to recognize detected speech and execute commands based on the received speech.

A number of data stores have also been discussed. It will be noted the data stores can each be broken into multiple data stores. In some examples, one or more of the data stores may be local to the systems accessing the data stores, one or more of the data stores may all be located remote form a system utilizing the data store, or one or more data stores may be local while others are remote. All of these configurations are contemplated by the present disclosure.

Also, the figures show a number of blocks with functionality ascribed to each block. It will be noted that fewer blocks can be used to illustrate that the functionality ascribed to multiple different blocks is performed by fewer components. Also, more blocks can be used illustrating that the functionality may be distributed among more components. In different examples, some functionality may be added, and some may be removed.

It will be noted that the above discussion has described a variety of different systems, components, logic, generators, and interactions. It will be appreciated that any or all of such systems, components, logic, generators, and interactions may be implemented by hardware items, such as one or more processors, one or more processors executing computer executable instructions stored in memory, memory, or other processing components, some of which are described below, that perform the functions associated with those systems, components, logic, generators, or interactions. In addition, any or all of the systems, components, logic, generators, and interactions may be implemented by software that is loaded into a memory and is subsequently executed by one or more processors or one or more servers or other computing component(s), as described below. Any or all of the systems, components, logic, generators, and interactions may also be implemented by different combinations of hardware, software, firmware, etc., some examples of which are described below. These are some examples of different structures that may be used to implement any or all of the systems, components, logic, generators, and interactions described above. Other structures may be used as well.

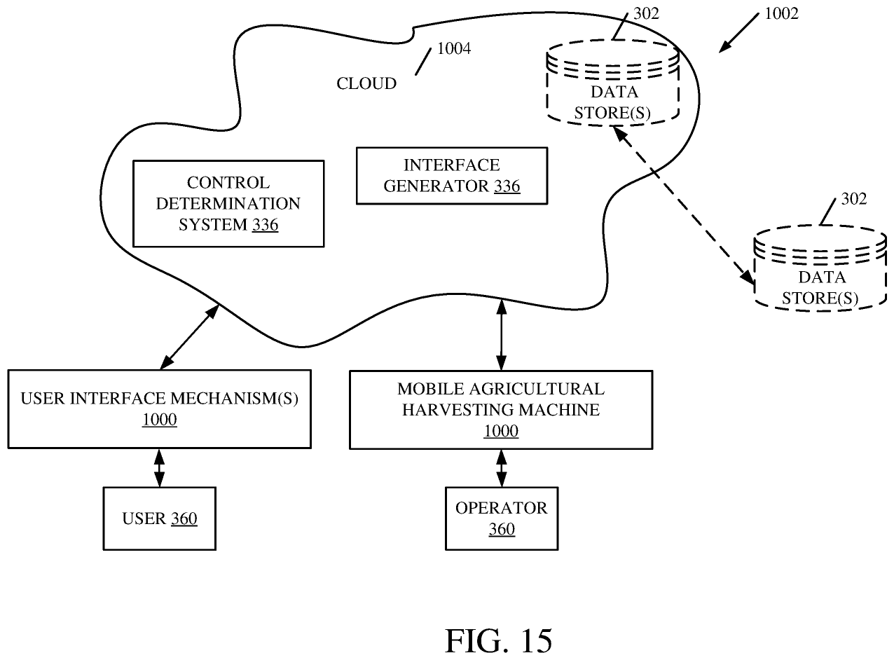

FIG. 15 is a block diagram of mobile agricultural harvesting machine 1000 (also referred to as harvester 1000), which may be similar to mobile agricultural harvesting machine 100. The mobile agricultural harvesting machine 1000 communicates with elements in a remote server architecture 1002. In some examples, remote server architecture 1002 provides computation, software, data access, and storage services that do not require end-user knowledge of the physical location or configuration of the system that delivers the services. In various examples, remote servers may deliver the services over a wide area network, such as the internet, using appropriate protocols. For instance, remote servers may deliver applications over a wide area network and may be accessible through a web browser or any other computing component. Software or components shown in previous figures as well as data associated therewith, may be stored on servers at a remote location. The computing resources in a remote server environment may be consolidated at a remote data center location, or the computing resources may be dispersed to a plurality of remote data centers. Remote server infrastructures may deliver services through shared data centers, even though the services appear as a single point of access for the user. Thus, the components and functions described herein may be provided from a remote server at a remote location using a remote server architecture. Alternatively, the components and functions may be provided from a server, or the components and functions can be installed on client devices directly, or in other ways.

In the example shown in FIG. 15, some items are similar to those shown in previous figures and those items are similarly numbered. FIG. 15 specifically shows that interface generator 333 and control determination system 336 may be located at a server location 1004 that is remote from the harvester 1000. Therefore, in the example shown in FIG. 15, harvester 1000 accesses those items through remote server location 1004. In other examples, various other items may also be located at server location 1004, such as data stores 302, other components of control system 314, as well as various other items.

FIG. 15 also depicts another example of a remote server architecture. FIG. 15 shows that some elements of previous figures may be disposed at a remote server location 1004 while others may be located elsewhere. By way of example, data store s302 may be disposed at a location separate from location 1004 and accessed via the remote server at location 1004. Regardless of where the elements are located, the elements can be accessed directly by harvester 1000 through a network such as a wide area network or a local area network; the elements can be hosted at a remote site by a service; or the elements can be provided as a service or accessed by a connection service that resides in a remote location. Also, data may be stored in any location, and the stored data may be accessed by, or forwarded to, operators, users, or systems. For instance, physical carriers may be used instead of, or in addition to, electromagnetic wave carriers. In some examples, where wireless telecommunication service coverage is poor or nonexistent, another machine, such as a fuel truck or other mobile machine or vehicle, may have an automated, semi-automated or manual information collection system. As the harvester 1000 comes close to the machine containing the information collection system, such as a fuel truck prior to fueling, the information collection system collects the information from the harvester 1000 using any type of ad-hoc wireless connection. The collected information may then be forwarded to another network when the machine containing the received information reaches a location where wireless telecommunication service coverage or other wireless coverage is available. For instance, a fuel truck may enter an area having wireless communication coverage when traveling to a location to fuel other machines or when at a main fuel storage location. All of these architectures are contemplated herein. Further, the information may be stored on the harvester 1000 until the harvester 1000 enters an area having wireless communication coverage. The harvester 1000, itself, may send the information to another network.

It will also be noted that the elements of previous figures, or portions thereof, may be disposed on a wide variety of different devices. One or more of those devices may include an on-board computer, an electronic control unit, a display unit, a server, a desktop computer, a laptop computer, a tablet computer, or other mobile device, such as a palm top computer, a cell phone, a smart phone, a multimedia player, a personal digital assistant, etc.

In some examples, remote server architecture 1002 may include cybersecurity measures. Without limitation, these measures may include encryption of data on storage devices, encryption of data sent between network nodes, authentication of people or processes accessing data, as well as the use of ledgers for recording metadata, data, data transfers, data accesses, and data transformations. In some examples, the ledgers may be distributed and immutable (e.g., implemented as blockchain).

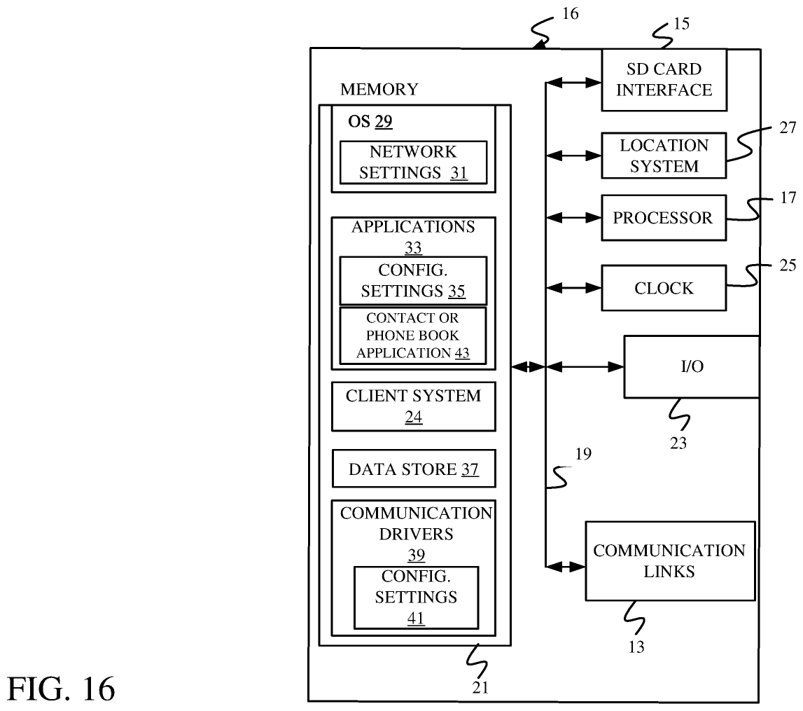

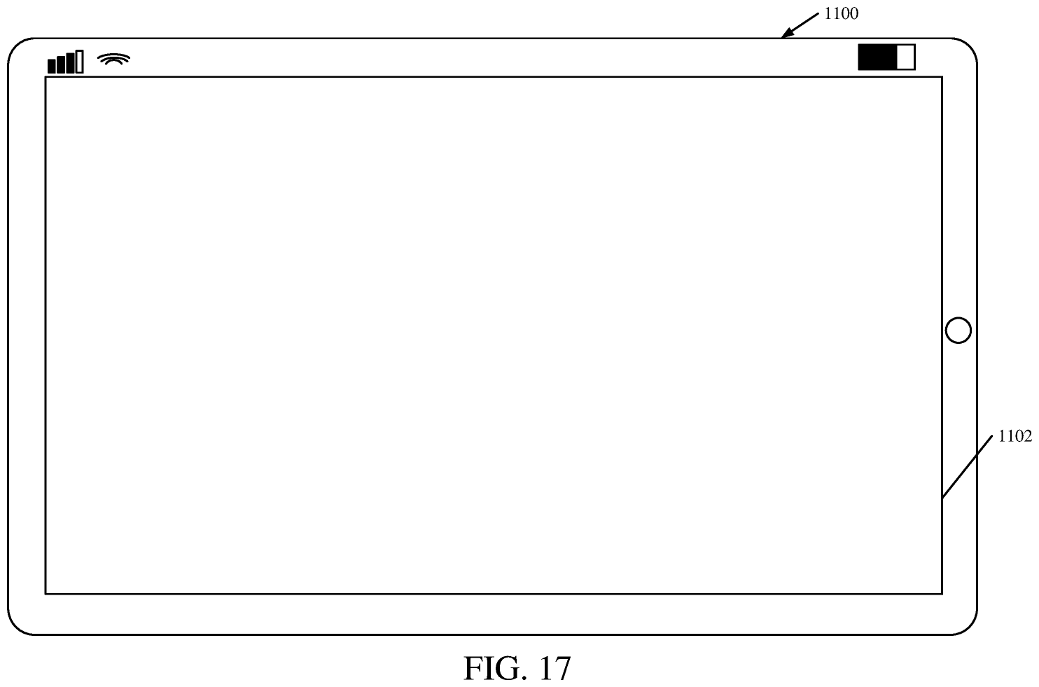

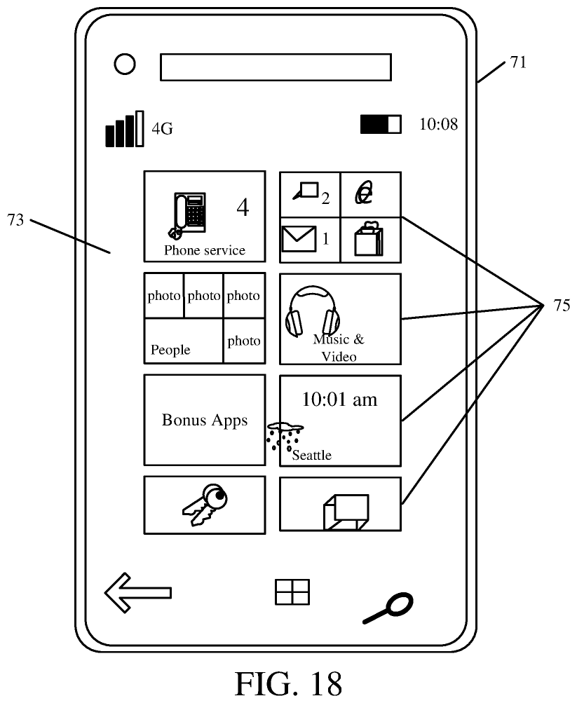

FIG. 16 is a simplified block diagram of one illustrative example of a handheld or mobile computing device that can be used as a user's or client's handheld device 16, in which the present system (or parts of it) can be deployed. For instance, a mobile device can be deployed in the operator compartment of harvester 100 for use in providing or implementing functionality discussed herein. FIGS. 17-18 are examples of handheld or mobile devices.

FIG. 16 provides a general block diagram of the components of a client device 16 that can run some components shown in previous figures, that interacts with them, or both. In the device 16, a communications link 13 is provided that allows the handheld device to communicate with other computing devices and under some examples provides a channel for receiving information automatically, such as by scanning. Examples of communications link 13 include allowing communication though one or more communication protocols, such as wireless services used to provide cellular access to a network, as well as protocols that provide local wireless connections to networks.

In other examples, applications can be received on a removable Secure Digital (SD) card that is connected to an interface 15. Interface 15 and communication links 13 communicate with a processor 17 (which can also embody processors or servers from other figures described herein) along a bus 19 that is also connected to memory 21 and input/output (I/O) components 23, as well as clock 25 and location system 27.

I/O components 23, in one example, are provided to facilitate input and output operations. I/O components 23 for various examples of the device 16 can include input components such as buttons, touch sensors, optical sensors, microphones, touch screens, proximity sensors, accelerometers, orientation sensors and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. Location system 27 can also include, for example, mapping software or navigation software that generates desired maps, navigation routes and other geographic functions.

Memory 21 stores operating system 29, network settings 31, applications 33, application configuration settings 35, contact or phone book application 43, client system 24, data store 37, communication drivers 39, and communication configuration settings 41. Memory 21 can include all types of tangible volatile and non-volatile computer-readable memory devices. Memory 21 may also include computer storage media (described below). Memory 21 stores computer readable instructions that, when executed by processor 17, cause the processor to perform computer-implemented steps or functions according to the instructions. Processor 17 may be activated by other components to facilitate their functionality as well.

FIG. 7 shows one example in which device 16 is a tablet computer 1100. In FIG. 17, computer 1100 is shown with user interface display screen 1102. Screen 1102 can be a touch screen or a pen-enabled interface that receives inputs from a pen or stylus. Tablet computer 1100, may also use an on-screen virtual keyboard. Of course, computer 1100 might also be attached to a keyboard or other user input device through a suitable attachment mechanism, such as a wireless link or USB port, for instance. Computer 1100 may also illustratively receive voice inputs as well.

FIG. 18 is similar to FIG. 17 except that the device is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

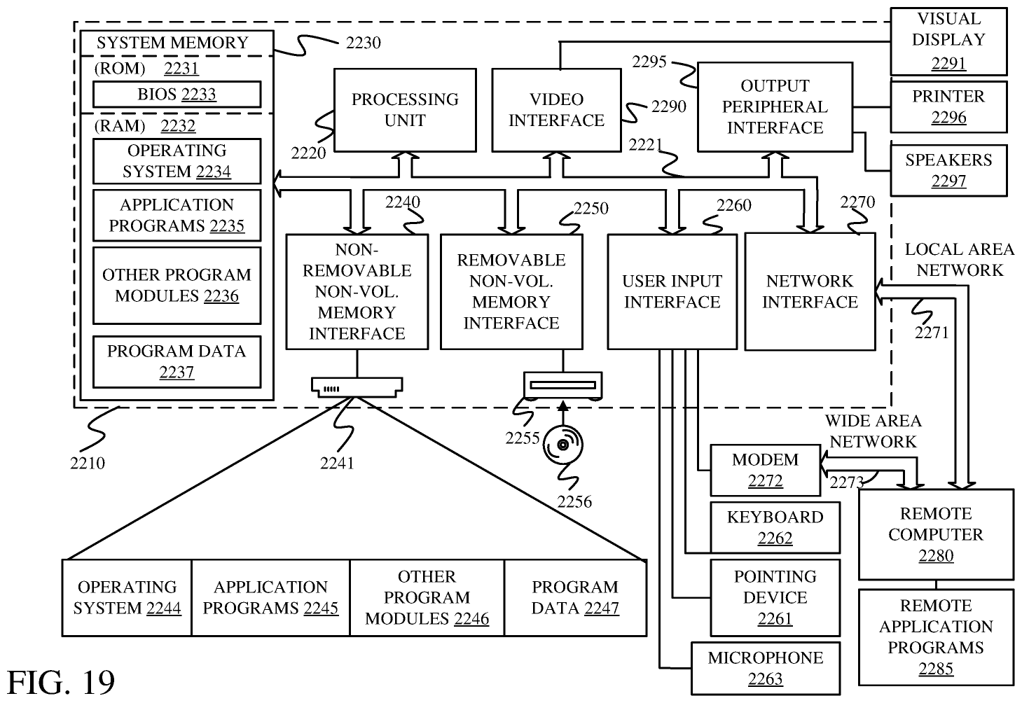

FIG. 19 is one example of a computing environment in which elements of previous figures described herein can be deployed. With reference to FIG. 19, an example system for implementing some embodiments includes a computing device in the form of a computer 2210 programmed to operate as discussed above. Components of computer 2210 may include, but are not limited to, a processing unit 2220 (which can comprise processors or servers from previous figures described herein), a system memory 2230, and a system bus 2221 that couples various system components including the system memory to the processing unit 2220. The system bus 2221 may be any of several types of bus structures including a memory bus or memory controller, a peripheral bus, and a local bus using any of a variety of bus architectures. Memory and programs described with respect to previous figures described herein can be deployed in corresponding portions of FIG. 19.

Computer 2210 typically includes a variety of computer readable media. Computer readable media may be any available media that can be accessed by computer 2210 and includes both volatile and nonvolatile media, removable and non-removable media. By way of example, and not limitation, computer readable media may comprise computer storage media and communication media. Computer storage media is different from, and does not include, a modulated data signal or carrier wave. Computer readable media includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 2210. Communication media may embody computer readable instructions, data structures, program modules or other data in a transport mechanism and includes any information delivery media. The term “modulated data signal” means a signal that has one or more of its characteristics set or changed in such a manner as to encode information in the signal.

The system memory 2230 includes computer storage media in the form of volatile and/or nonvolatile memory or both such as read only memory (ROM) 2231 and random access memory (RAM) 2232. A basic input/output system 2233 (BIOS), containing the basic routines that help to transfer information between elements within computer 2210, such as during start-up, is typically stored in ROM 2231. RAM 2232 typically contains data or program modules or both that are immediately accessible to and/or presently being operated on by processing unit 2220. By way of example, and not limitation, FIG. 19 illustrates operating system 2234, application programs 2235, other program modules 2236, and program data 2237.

The computer 2210 may also include other removable/non-removable volatile/nonvolatile computer storage media. By way of example only, FIG. 19 illustrates a hard disk drive 2241 that reads from or writes to non-removable, nonvolatile magnetic media, an optical disk drive 2255, and nonvolatile optical disk 2256. The hard disk drive 2241 is typically connected to the system bus 2221 through a non-removable memory interface such as interface 2240, and optical disk drive 2255 are typically connected to the system bus 2221 by a removable memory interface, such as interface 2250.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (e.g., ASICs), Application-specific Standard Products (e.g., ASSPs), System-on-a-chip systems (SOCs), Complex Programmable Logic Devices (CPLDs), etc.

The drives and their associated computer storage media discussed above and illustrated in FIG. 19, provide storage of computer readable instructions, data structures, program modules and other data for the computer 2210. In FIG. 19, for example, hard disk drive 1241 is illustrated as storing operating system 2244, application programs 2245, other program modules 2246, and program data 2247. Note that these components can either be the same as or different from operating system 2234, application programs 2235, other program modules 2236, and program data 2237.

A user may enter commands and information into the computer 2210 through input devices such as a keyboard 2262, a microphone 2263, and a pointing device 2261, such as a mouse, trackball or touch pad. Other input devices (not shown) may include a joystick, game pad, satellite dish, scanner, or the like. These and other input devices are often connected to the processing unit 2220 through a user input interface 2260 that is coupled to the system bus, but may be connected by other interface and bus structures. A visual display 2291 or other type of display device is also connected to the system bus 2221 via an interface, such as a video interface 2290. In addition to the monitor, computers may also include other peripheral output devices such as speakers 2297 and printer 2296, which may be connected through an output peripheral interface 2295.

The computer 2210 is operated in a networked environment using logical connections (such as a controller area network—CAN, local area network—LAN, or wide area network WAN) to one or more remote computers, such as a remote computer 2280.

When used in a LAN networking environment, the computer 2210 is connected to the LAN 2271 through a network interface or adapter 2270. When used in a WAN networking environment, the computer 2210 typically includes a modem 2272 or other means for establishing communications over the WAN 2273, such as the Internet. In a networked environment, program modules may be stored in a remote memory storage device. FIG. 19 illustrates, for example, that remote application programs 2285 can reside on remote computer 2280.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of the claims.

What is claimed is:

1. A mobile agricultural harvester comprising:
a grain camera configured to detect grain and generate a camera output indicative of the detected grain;
a display screen;
one or more processors
memory; and
computer executable instructions, stored in the memory, and executable by the one or more processors, the computer executable instructions, when executed by the one or more processors, configure the one or more processors to:
generate an interface comprising:
a grain camera display portion comprising a grain camera display element;
a grain characteristic value display portion comprising a grain characteristic value display element indicative of a value of grain characteristic of the detected grain; and
a limit value adjuster display portion comprising an interactable limit value adjuster display element configured to receive operator or user interaction to adjust a limit value of the grain characteristic; and
display the interface on the display screen.

2. The mobile agricultural harvester of claim 1, wherein the grain characteristic is grain cleanliness or grain brokenness.

3. The mobile agricultural harvester of claim 1, wherein the interactable limit value adjuster display element comprises a scale and a slider configured to move along the scale in response to the operator or user interaction to adjust the limit value of the grain characteristic.

4. The mobile agricultural harvester of claim 3, wherein the slider is configured to receive the operator or user interaction.

5. The mobile agricultural harvester of claim 3, wherein the interactable limit value adjuster display element further comprises a first interactable adjuster element configured to receive the operator or user interaction to move the slider in a first direction along the scale and a second interactable adjuster element configured to receive the operator or user interaction to move the slider in a second direction along the scale.

6. The mobile agricultural harvester of claim 1, wherein the computer executable instructions, when executed by the one or more processors, further configure the one or more processors to generate the interface further comprising:
a limit value display portion comprising a limit value display element indicative of the limit value of the grain characteristic.

7. The mobile agricultural harvester of claim 6, wherein the limit value display element is a textual representation of the limit value of the grain characteristic.

8. The mobile agricultural harvester of claim 6, wherein the interactable limit value adjuster display element comprises a scale and a slider configured to move along the scale in response to the operator or user interaction to adjust the limit value of the grain characteristic and wherein the limit value display element is a mark incorporated into the scale.

9. The mobile agricultural harvester of claim 1, wherein the camera output is an image or a video feed of the grain camera and wherein the grain camera display element displays the image or the video feed of the grain camera based on the camera output.

10. The mobile agricultural harvester of claim 1, wherein the grain camera display element is an interactable grain camera display element configured to receive an input from a user or an operator and wherein the computer executable instructions, when executed by the one or more processors, further configure the one or more processors to:
generate, based on input from the user or the operator, an additional interface comprising:
an additional grain camera display portion comprising an additional grain camera display element that displays an image or a video feed of the grain camera based on the camera output; and
an additional limit value adjuster display portion comprising an additional interactable limit value adjuster display element that is interactable to adjust the grain characteristic limit value; and
display the additional interface on the display screen.

11. The mobile agricultural harvester of claim 1 and further comprising a controllable subsystem and wherein the computer executable instructions, when executed by the one or more processors, further configure the one or more processors to:
identify an adjusted limit value of the grain characteristic based on the operator or user interaction;
identify a current value of the grain characteristic based on the camera output; and
generate a control signal to control the controllable subsystem based on the adjusted limit value of the grain characteristic and based on the current value of the grain characteristic.

12. The mobile agricultural harvester of claim 1, wherein the grain characteristic value display element comprises a first grain characteristic value display element indicative of a value of grain brokenness of the detected grain, wherein the interactable limit value adjuster display element is a first interactable limit value adjuster display element configured to receive operator or user interaction to adjust a limit value of grain brokenness, wherein the interface further comprises:
a second grain characteristic value display element indicative of a value of grain cleanliness of the detected grain; and
a second interactable limit value adjuster display element configured to receive operator or user interaction to adjust a limit value of grain cleanliness.

13. A computer implemented method comprising:
obtaining a camera output indicative of grain detected by a grain camera;
at an interface mechanism, associated with a mobile agricultural harvester, with a display screen:
in a grain camera display portion of the display screen, displaying a grain camera display element;
in a grain characteristic value display portion of the display screen, displaying a grain characteristic value display element indicative of a value of a grain characteristic; and
in a limit value adjuster display portion of the display screen, displaying an interactable limit value adjuster display element configured to receive operator or user interaction to adjust a limit value of the grain characteristic.

14. The computer implemented method of claim 13, wherein displaying the grain camera display element comprises displaying the grain camera display element to display an image or video feed of the grain camera based on the camera output and a color overlay over grain in the image or video feed to indicate the grain characteristic.

15. The computer implemented method of claim 13, wherein displaying the interactable limit value adjuster display element comprises displaying the interactable limit value adjuster display element including a scale and a slider, the slider moveable, based on the operator or user interaction with the interactable limit value adjuster display element, along the scale in a first direction to increase the limit value of the grain characteristic and in a second direction to decrease the limit value of the grain characteristic.

16. The computer implemented method of claim 15, wherein displaying the grain characteristic value display element comprises displaying the grain characteristic value display element as a mark incorporated into the scale.

17. The computer implemented method of claim 16, wherein the scale includes a plurality of marks, a first subset of the plurality of marks displayed towards a first side of the grain characteristic value display element mark in the first direction and a second subset of the plurality of marks displayed towards a second side of the grain characteristic value display element mark in the second direction.

18. The computer implemented method of claim 12 and further comprising:
in a limit value display portion of the display screen, displaying a limit value display element indicative of a limit value of the grain characteristic.

19. The computer implemented method of claim 12 and further comprising:
identifying an adjusted limit value of the grain characteristic based on the operator or user interaction;
identifying a current value of the grain characteristic; and
generating a control signal to control a controllable subsystem of the mobile agricultural harvester based on the adjusted limit value of the grain characteristic and based on the current value of the grain characteristic.

20. An agricultural harvesting system comprising:
a grain camera configured to detect grain and generate a camera output indicative of the detected grain;
a display screen;
one or more processors;
memory; and
computer executable instruction, stored in the memory, and executable by the one or more processors, the computer executable instructions, when executed by the one or more processors, configure the one or more processors to:
generate an interface comprising
a grain camera display portion comprising a grain camera display element;
a grain characteristic value display portion comprising a grain characteristic value display element indicative of a value of a grain characteristic of the detected grain; and
a limit value adjuster display portion comprising an interactable limit value adjuster display element configured to receive operator or user interaction to adjust a limit value of the grain characteristic; and
display the interface on the display screen.
